(19) United States
(12) Patent Application Publication
(10) Pub. No.: US 2024/0408886 A1
(43) Pub. Date: Dec. 12, 2024

(54) INK JET PRINTING METHOD

(71) Applicant: CANON KABUSHIKI KAISHA, Tokyo (JP)

(72) Inventors: SAORI NARUKAWA, Kanagawa (JP); FUMI TANAKA, Kanagawa (JP); KOICHI ISHIDA, Tokyo (JP); KYOSUKE TODA, Kanagawa (JP); YOSHIHIRO HAMADA, Kanagawa (JP); MIKIO SANADA, Kanagawa (JP); SHOICHI TAKEDA, Kanagawa (JP); YOSHIYUKI KANEKO, Kanagawa (JP); TAKATSUGU MORIYA, Tokyo (JP)

(21) Appl. No.: 18/737,404

(22) Filed: Jun. 7, 2024

(30) Foreign Application Priority Data
Jun. 12, 2023 (JP) 2023-095973

(51) Int. Cl. B41J 2/18; B41J 2/175; B41M 3/00; C09D 11/037; C09D 11/322; C09D 11/54

(52) U.S. Cl. CPC B41J 2/18; B41J 2/17596; B41M 3/001; C09D 11/037; C09D 11/322; C09D 11/54

(57) ABSTRACT

In an ink jet printing method for printing an image on a print medium by discharging an aqueous ink and an aqueous reaction liquid containing a reactant that reacts with the aqueous ink from a liquid discharge head, the liquid discharge head includes an element substrate, upstream and downstream flow channels, a pump, and a temperature control unit. The element substrate includes a discharge port discharging the aqueous reaction liquid, a pressure chamber supplying a liquid to the discharge port, and a discharge element generating energy for discharging the liquid. The upstream flow channel supplies a liquid to the pressure chamber. The downstream flow channel communicates with the pressure chamber. The pump communicates with the upstream and downstream flow channels and allows a liquid in the downstream flow channel to flow in the upstream flow channel. The temperature control unit heats the aqueous ink or the aqueous reaction liquid.

### BACKGROUND

### Field

The present disclosure relates to an ink jet printing method.

### Description of the Related Art

In recent years, ink jet printing methods are increasingly being used in the field of called sign and display, such as printing posters and large format advertisements. In this field, a feature is that the printing area is broad compared to home-use ink jet printing apparatuses. In addition, since it is necessary that images are eye-catching, inks that can print images with high color development properties are required.

In the field of sign and display, a non-absorbable print medium whose surface has almost no ink absorbency, made of vinyl chloride (VC), polypropylene terephthalate (PET), or the like, is often used. Accordingly, it is required to suppress blur and unevenness of images on a non-absorbable print medium. Hereinafter, a print medium having a surface with almost no ink absorbency is also referred to as “non-absorbable print medium”. In an ink jet printing method for printing on a non-absorbable print medium, it is important to suppress blur by preventing ink dots from being repelled on the print medium. Accordingly, it is necessary to rapidly thicken and solidify an ink after application of the ink to a print medium.

As the method for printing on a non-absorbable print medium, a printing method using a solvent-based ink containing an organic solvent as the main component or a curable ink containing a polymerizable monomer is known. However, in the recent years, from the viewpoint of environmental load and safety, there is a growing need for a printing method that can print on a non-absorbable print medium using an aqueous ink.

Examples of the method for printing on a non-absorbable print medium using an aqueous ink include a method by evaporating moisture in the ink on the surface of a non-absorbable print medium and a method using a reaction liquid that aggregates ink components. The former does not need to provide a device for applying the reaction liquid and is therefore advantageous from the viewpoint of running cost, but it is required to decrease the printing speed and is therefore poor in productivity. Accordingly, a method using a reaction liquid is being investigated.

In order to improve productivity, it is necessary to shorten the time required for maintenance of the liquid discharge head and to enable continuous printing. The maintenance of a liquid discharge head is necessary for suppressing a decrease in the discharge properties due to thickening of a reaction liquid or an ink at the discharge port that is not mainly used or solidification of components, such as a pigment and a resin, in a reaction liquid or an ink during continuous printing. Accordingly, it is demanded to use a reaction liquid, and also there is a need for an ink jet printing method that maintains stable discharge without interruption of printing even during long-term continuous printing.

Also, in the past, a liquid discharge head having a mechanism for flowing an ink in the vicinity of the discharge port of the liquid discharge head has been proposed in order to suppress stagnation of ink components, such as a pigment and a resin, in the ink flow channel of the liquid discharge head (see Japanese Patent Laid-Open No. 2007-118611). In addition, in order to improve the cleaning recoverability of the discharge port for discharging a reaction liquid, an ink jet printing method using a liquid discharge head including a circulation flow channel has been proposed (see Japanese Patent Laid-Open No. 2020-104487).

The present inventors investigated for various characteristics of the liquid discharge head having a mechanism for flowing an ink in the vicinity of the discharge port of the liquid discharge head described in Japanese Patent Laid-Open No. 2007-118611 and the ink jet printing method using a liquid discharge head described in Japanese Patent Laid-Open No. 2020-104487. As a result, it was found that in the configuration described in Japanese Patent Laid-Open No. 2007-118611, the intermittent discharge stability of a reaction liquid could be obtained to some extent, but image unevenness occurs. It was also found that in Japanese Patent Laid-Open No. 2020-104487, although a circulation flow channel is provided, since an ink flow is not generated in the vicinity of the discharge port, the intermittent discharge stability of a reaction liquid is insufficient. “The intermittent discharge stability of a reaction liquid is insufficient” means that when a state in which a reaction liquid is not discharged for a certain period of time is continued, a liquid component in the reaction liquid evaporates from a part of discharge ports, and the discharge conditions of the reaction liquid from the discharge ports gradually become unstable. That is, intermittent discharge stability refers to characteristics not causing unstable discharge or discharge failure of a reaction liquid even in the above-mentioned state and hardly causing quality deterioration in printed images.

### SUMMARY

The present disclosure provides an ink jet printing method that can maintain stable discharge of a reaction liquid and can suppress occurrence of image unevenness.

According to an aspect of the present disclosure, provided is an ink jet printing method for printing an image on a print medium by discharging each of an aqueous ink and an aqueous reaction liquid containing a reactant that reacts with the aqueous ink from a liquid discharge head, wherein the liquid discharge head comprises: an element substrate including a discharge port for discharging the aqueous reaction liquid, a pressure chamber for supplying a liquid to the discharge port, and a discharge element for generating energy for discharging the liquid, an upstream flow channel for supplying a liquid to the pressure chamber, a downstream flow channel communicating with the pressure chamber, a pump communicating with the upstream flow channel and the downstream flow channel, and a temperature control unit configured to heat the aqueous ink or the aqueous reaction liquid, and the method comprises operating the pump such that a liquid in the downstream flow channel flow in the upstream flow channel.

Further features of the present disclosure will become apparent from the following description of exemplary embodiments with reference to the attached drawings.

### BRIEF DESCRIPTION OF THE DRAWINGS

FIG. 1A is a perspective view for explaining a liquid discharge apparatus.

FIG. 1B is a block diagram illustrating the control system of a liquid discharge apparatus.

FIG. 2 is an exploded perspective view of a liquid discharge head.

FIG. 3A shows a vertical section of a liquid discharge head.

FIG. 3B is an enlarged cross-sectional view of a discharge module.

FIG. 4 is an external appearance schematic view of a circulation unit.

FIG. 5 is a vertical sectional view illustrating a circulation path.

FIG. 6 is a block diagram schematically illustrating the circulation path.

FIGS. 7A to 7C are cross-sectional views illustrating an example of a pressure regulation unit.

FIGS. 8A and 8B are external appearance perspective views of a circulation pump.

FIG. 9 is a line IX-IX cross-sectional view of the circulation pump shown in FIG. 8A.

FIGS. 10A to 10E are diagrams for explaining a flow of an ink in a liquid discharge head.

FIGS. 11A and 11B are schematic views illustrating a circulation path in a discharge unit.

FIG. 12 is a diagram illustrating an opening plate 330.

FIG. 13 is a diagram illustrating a discharge element substrate.

FIGS. 14A to 14C are cross-sectional views illustrating an ink flow in a discharge unit.

FIGS. 15A and 15B are cross-sectional views illustrating the vicinity of a discharge port.

FIGS. 16A and 16B are cross-sectional views illustrating a comparative example of the vicinity of a discharge port.

FIG. 17 is a diagram illustrating a comparative example of a discharge element substrate.

FIGS. 18A and 18B are diagrams illustrating a flow channel configuration of a liquid discharge head.

FIG. 19 is a diagram illustrating a connection status of a main body portion and a liquid discharge head of a liquid discharge apparatus.

FIG. 20 is a diagram illustrating a discharge element substrate including a temperature control unit.

### DESCRIPTION OF THE EMBODIMENTS

The present disclosure will now be described in detail by referring to embodiments. In the following description, an aqueous ink and a reaction liquid for ink jet printing may be simply referred to as an “ink” and a “reaction liquid”, respectively.

The present inventors studied the issues that occur in the liquid discharge heads such as those described in Japanese Patent Laid-Open Nos. 2007-118611 and 2020-104487. As a result, it was thought that the intermittent discharge stability of a reaction liquid is improved and the occurrence of image unevenness can be suppressed by using a liquid discharge head having a configuration described below and flowing a reaction liquid in the liquid discharge head. Specifically, the liquid discharge head to be used includes a discharge port for discharging a reaction liquid, a pressure chamber including a discharge element for generating energy for discharging the reaction liquid, an upstream flow channel for supplying a liquid to the pressure chamber, a downstream flow channel communicating with the pressure chamber, and a pump communicating with the upstream flow channel and downstream flow channel and configured such that the liquid in the downstream flow channel flows into the upstream flow channel.

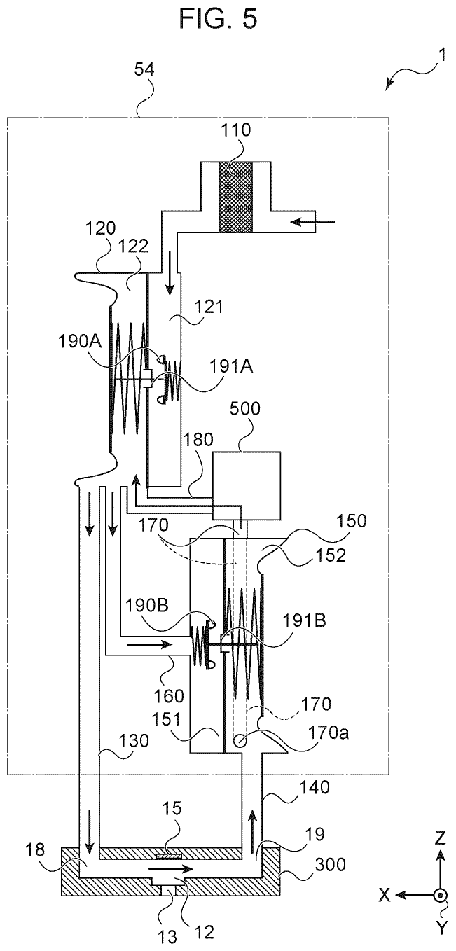

The flow of a reaction liquid will be described with reference to FIG. 5. FIG. 5 is a cross-sectional view illustrating the vicinity of a discharge port 13 in an example of the liquid discharge head of the present disclosure described later. The liquid discharge head shown in FIG. 5 includes a discharge port 13 for discharging a reaction liquid, a pressure chamber 12 including a discharge element 15 that generates energy for discharging the reaction liquid, and a common supply channel 18 (upstream flow channel) and a common collection channel 19 (downstream flow channel) which communicate with each other between the discharge port 13 and the discharge element 15 and in which the reaction liquid flows. The reaction liquid passes through between the discharge port 13 and the discharge element 15 and flows in the common supply channel 18 and the common collection channel 19 (in the direction indicated by the arrow in FIG. 5). When the reaction liquid is not flowing, evaporation of a liquid component from the meniscus at the discharge port 13 progresses, along with this, the reaction liquid present between the discharge port 13 and the discharge element 15 gradually thickens. Consequently, if the discharge intermission period is long, the liquid resistance of the reaction liquid of the subsequent discharge operation increases, and the discharge of the liquid may become difficult. On the other hand, when the reaction liquid is flowing, since the reaction liquid moves to the direction indicated by the arrows in FIG. 5, even if the liquid component evaporates from the meniscus, the reaction liquid is supplied successively between the discharge port 13 and the discharge element 15 by the flow of the reaction liquid. Accordingly, the reaction liquid is prevented from thickening, and it is possible to make it difficult to cause a situation in which the discharge is difficult. Consequently, intermittent discharge stability can be improved.

The flow rate (mm/s) of the reaction liquid in the pressure chamber 12 may be 1.0 mm/s or more and 50.0 mm/s or less. When the flow rate of the reaction liquid is less than 1.0 mm/s, the supply of the reaction liquid to near the meniscus is insufficient, and intermittent discharge stability may not be obtained due to the influence of evaporation. When the flow rate of the reaction liquid is greater than 50.0 mm/s, the flow rate is too high, a change in the physical properties of the reaction liquid due to evaporation tends to occur, and image unevenness may not be sufficiently prevented.

The studies by the present inventors also revealed that the use of a liquid discharge head in which a reaction liquid flows improves the intermittent discharge stability, but the discharge balance between the reaction liquid and the ink is disrupted due to a difference in viscosity between the reaction liquid and the ink, and image unevenness may occur. Against this issue, the present inventors investigated methods to address the issue by a configuration of the liquid discharge apparatus for discharging an ink and a reaction liquid, and arrived at a method in which a temperature control unit for an ink or a reaction liquid is provided to the liquid discharge apparatus. The details of the temperature control unit will be described later.

### Ink Jet Printing Method

The ink jet printing method of the present disclosure is a method for printing an image on a print medium by discharging an aqueous ink and aqueous reaction liquid described later from a liquid discharge head of an ink jet system. The method may include a reaction liquid discharge step of discharging an aqueous reaction liquid containing a reactant that reacts with an aqueous ink from a discharge port to a print medium and an ink application step of applying the aqueous ink so as to overlap at least part of the region to which the aqueous reaction liquid is applied. Furthermore, the reaction liquid discharge step may be performed before the ink application step, or the ink application step and the reaction liquid discharge step may be performed in parallel. In the present disclosure, there is no need to provide a step of hardening an image by irradiation with active energy rays or the like.

The print medium is not particularly limited, and a transparent or colored print medium can be used. The print medium may be a poorly absorbable medium (non-absorbable medium) that has low liquid medium absorbency, such as a resin film. The application of an ink to a unit region of a print medium may be multipass printing that performs relative scan of the liquid discharge head and the print medium multiple times. In particular, when a white ink is used as described later, application of the white ink and application of a color ink or the aqueous reaction liquid to a unit region may be performed by different relative scans. Consequently, the time until the inks come into contact with each other becomes longer, which tends to suppress mixing thereof. The unit region can be set as an arbitrary region such as one pixel or one band.

### (1) Liquid Discharge Apparatus

Regarding the liquid discharge apparatus (ink jet printing apparatus) that can be used in the ink jet printing method of the present disclosure, a suitable embodiment of the present disclosure will now be described in detail with reference to the accompanying drawings. The embodiments below does not limit the subject matter of the present disclosure, and not all combinations of features described in the present embodiment are essential to the solution of the present disclosure. Identical components are given the same reference numbers. In the present embodiment, an example adopting a thermal system for discharging a liquid by generating air bubbles by an electrothermal conversion element as a discharge element for discharging a liquid will be described, but the discharge element is not limited thereto. The present disclosure can also be applied to a liquid discharge head adopting a discharge system for discharging a liquid using a piezoelectric element (piezo) or another discharge system. Furthermore, a pump, a pressure regulation unit, and so on described below are also not limited to the configurations themselves described in the embodiments and drawings.

### Liquid Discharge Apparatus

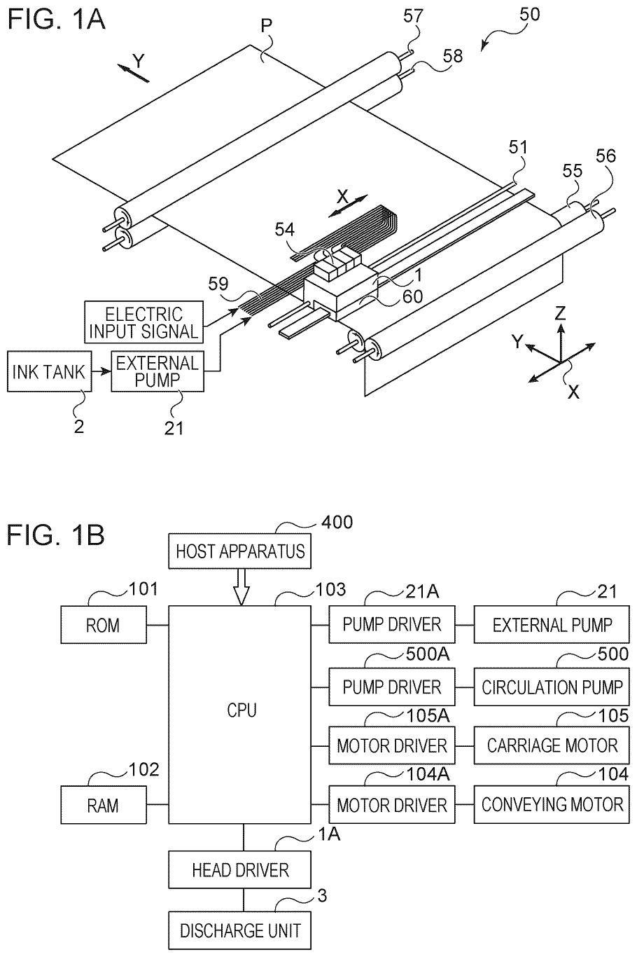

FIGS. 1A and 1B are diagrams for explaining a liquid discharge apparatus and FIG. 1A is enlarged views of a liquid discharge head of a liquid discharge apparatus and the vicinity thereof. A schematic configuration of the liquid discharge apparatus 50 according to the present embodiment will be described with reference to FIGS. 1A and 1B. FIG. 1A is a perspective view schematically illustrating a liquid discharge apparatus using a liquid discharge head 1. The liquid discharge apparatus 50 of the present embodiment constitutes a serial-type ink jet printing apparatus that performs printing on a print medium P by discharging an ink or a reaction liquid (described later) as a liquid while scanning a liquid discharge head 1. Hereinafter, the “liquid” in the present disclosure includes an ink and a reaction liquid containing a reactant that reacts with the ink. Also in the following description, the term “ink” may be used so as to include an ink and a reaction liquid. The liquid discharge head 1 is loaded on the carriage 60. The carriage 60 reciprocally moves along a guide shaft 51 in the main scanning direction (X direction). The print medium P is conveyed by conveying rollers 55, 56, 57, and 58 to a sub-scanning direction (Y direction) crossing (in this example, orthogonal to) the main scanning direction. In each drawing referenced below, the Z direction indicates the vertical direction and crosses (in this example, orthogonal to) the X-Y plane that is defined by the X direction and the Y direction. The liquid discharge head 1 is configured to be detachable and attachable to the carriage 60 by a user.

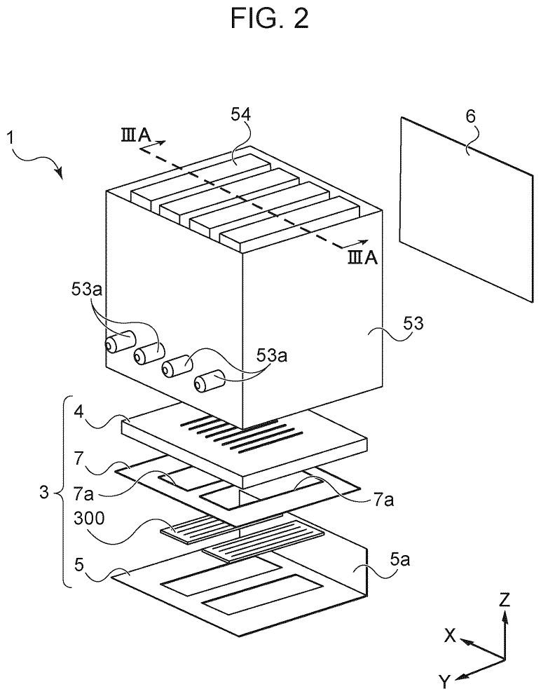

The liquid discharge head 1 is constituted by including a circulation unit 54 and a discharge unit 3 (see FIG. 2) described later. Although a specific configuration will be described later, the discharge unit 3 is provided with a plurality of discharge ports and an energy-generating element (hereinafter, referred to as discharge element) that emits discharge energy for discharging a liquid through each discharge port.

The liquid discharge apparatus 50 is provided with an ink tank 2 (liquid storage portion) as a supply source of a liquid and an external pump 21, and the liquid stored in the ink tank 2 is supplied to a circulation unit 54 by a driving force of the external pump 21 through a supply tube 59.

The liquid discharge apparatus 50 forms a prescribed image on a print medium P by repeating print scanning in which the liquid discharge head 1 loaded on the carriage 60 performs printing by discharging a liquid while moving in the main scanning direction and conveying operation of conveying the print medium P to the sub-scanning direction. The liquid discharge head 1 in the present embodiment is configured so as to be capable of discharging 4 types of liquids including an ink and a reaction liquid. However, the configuration of the ink jet printing apparatus in the present disclosure is not limited to one that discharges 4 types of liquids. For example, a configuration that can discharge inks of black (K), cyan (C), magenta (M), and yellow (Y) and a reaction liquid is exemplified. In this case, full color images can be printed by these inks. However, the liquids that can be discharged from the liquid discharge head 1 are not limited to the above-mentioned 4 types of inks and reaction liquid. The present disclosure can also be applied to a liquid discharge head for discharging other types of inks and reaction liquid.

That is, the type and the number of the liquids that are discharged from the liquid discharge head are not limited.

The liquid discharge apparatus 50 is provided with a cap member (not shown) that can cover the discharge port surface of the liquid discharge head where the discharge port is formed at a position deviated from the conveying path of a print medium P in the X direction. The cap member covers the discharge port surface of the liquid discharge head 1 during non-print operation and is used for drying prevention and protection of the discharge port, operation of liquid suction from the discharge port, and so on.

The liquid discharge head 1 shown in FIG. 1A is an example in which 4 circulation units 54 corresponding to 4 types of liquids are provided to a liquid discharge head 1, and it is sufficient as long as circulation units 54 according to the types of liquids to be discharged are provided. A plurality of circulation units 54 may be provided for the same type of a liquid. That is, the liquid discharge head 1 can be configured so as to include one or more circulation units. The configuration may be for circulating only at least one reaction liquid, not all 4 types of liquids are circulated.

FIG. 1B is a block diagram illustrating a control system of the liquid discharge apparatus 50. A CPU 103 serves a function as a control means for controlling the operation of each part of the liquid discharge apparatus 50 based on the program such as a processing procedure stored in a ROM 101. A RAM 102 is used as a work area or the like when the CPU 103 executes processing. The CPU 103 receives image data from a host apparatus 400 outside the liquid discharge apparatus 50 to control a head driver 1A and controls the drive of the discharge element provided to a discharge unit 3. The CPU 103 also controls drivers of various actuators provided in the liquid discharge apparatus. For example, the CPU 103 controls, for example, a motor driver 105A of a carriage motor 105 for moving the carriage 60 and a motor driver 104A of a conveying motor 104 for conveying a print medium P. Furthermore, the CPU 103 controls, for example, a pump driver 500A that drives a circulation pump 500 described later and a pump driver 21A that drives an external pump 21. FIG. 1B shows a configuration for performing processing of image data received from the host apparatus 400, but processing may be performed by the liquid discharge apparatus 50 without depending on data from the host apparatus 400.

### Basic Configuration of Liquid Discharge Head

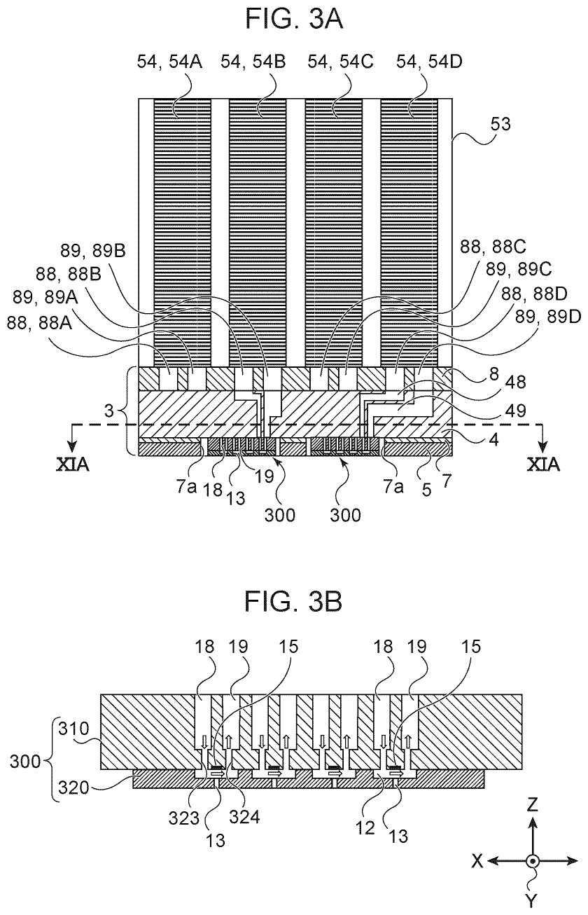

FIG. 2 is an exploded perspective view of a liquid discharge head 1 of the present embodiment. FIG. 3A is a line IIIA-IIIA cross-sectional view of the liquid discharge head 1 shown in FIG. 2. FIG. 3A is an overall vertical sectional view of the liquid discharge head 1, and FIG. 3B is an enlarged view of the discharge module 300 shown in FIG. 3A. Hereinafter, the basic configuration of the liquid discharge head 1 in the present embodiment will be described while focusing on FIGS. 2 and 3A and 3B, with appropriate reference to FIGS. 1A and 1B.

As shown in FIG. 2, the liquid discharge head 1 is constituted by including a circulation unit 54 and a discharge unit 3 for discharging an ink supplied from the circulation unit 54 onto a print medium P. The liquid discharge head 1 according to the present embodiment is fixed to and supported by the carriage 60 by a positioning means (not shown) and electric contact provided to the carriage 60 of the liquid discharge apparatus 50. The liquid discharge head 1 discharges an ink while moving together with the carriage 60 in the main scanning direction (X direction) shown in FIG. 1A to perform printing on a print medium P.

A supply tube 59 is provided to an external pump 21 connected to an ink tank 2 as a supply source of an ink (See FIG. 1A). The tip of this supply tube 59 is provided with a liquid connector (not shown). When the liquid discharge head 1 is loaded on the liquid discharge apparatus 50, the liquid connector provided to the tip of the supply tube 59 is airtightly connected to a liquid connector insertion port 53a that is an inlet port for a liquid provided to the head housing 53 of the liquid discharge head 1. Consequently, an ink supply path starting from the ink tank 2, passing through the external pump 21, and reaching the liquid discharge head 1 is formed. In the present embodiment, since 4 types of liquids are used, 4 sets of the ink tank 2, the external pump 21, the supply tube 59, and the circulation unit 54 are provided so as to correspond to the liquids, respectively, and 4 ink supply paths corresponding to the respective liquids are independently formed. Thus, the liquid discharge apparatus 50 of the present embodiment includes a liquid supply system to which liquids are supplied from the ink tank 2 disposed outside the liquid discharge head 1. The liquid discharge apparatus 50 of the present embodiment does not include an ink collection system for collecting the liquid in the liquid discharge head 1 in the ink tank 2. Accordingly, the liquid discharge head 1 is provided with a liquid connector insertion port 53a for connecting the supply tube 59 of the ink tank 2, but is not provided with a connector insertion port for connecting a tube for collecting the ink in the liquid discharge head 1 in the ink tank 2. The liquid connector insertion port 53a is provided for each ink.

In FIG. 3A, 54A indicates a circulation unit for a first ink, 54B indicates a circulation unit for a second ink, 54C indicates a circulation unit for a third ink, and 54D indicates a circulation unit for a reaction liquid. These circulation units have approximately the same configurations, and when the circulation units are not particularly distinguished, all of them is referred to as circulation unit 54 in the present embodiment.

As shown in FIGS. 3A and 3B, when the liquid discharge head includes both a circulation unit 54 for an ink and a circulation unit 54 for a reaction liquid, the circulation unit 54 for a reaction liquid may be located at an end in the arrangement direction where multiple circulation units 54 are arrayed. In printing operation, a reaction liquid is applied to a print medium by the reaction liquid discharge step of discharging an aqueous reaction liquid from a discharge port to a print medium, and then an ink application step of applying an aqueous ink may be performed so as to overlap at least part of the region to which the aqueous reaction liquid is applied. In such a case, the circulation unit for a reaction liquid is located at an end, which makes it possible to perform efficient printing.

In FIG. 2 and FIG. 3A, the discharge unit 3 includes two discharge modules 300, a first support member 4, a second support member 7, an electric wiring member (electric wiring tape) 5, and an electric contact substrate 6. As shown in FIG. 3B, the discharge module 300 includes a silicon substrate 310 having a thickness of 0.5 to 1 mm and a plurality of discharge elements 15 disposed on one surface of the silicon substrate 310. The discharge element 15 in the present embodiment is configured of an electrothermal conversion element (heater) that generates thermal energy as the discharge energy for discharging a liquid. Electric power is supplied to each discharge element 15 through electric wiring formed on the silicon substrate 310 by film formation technique. A discharge port forming member 320 is formed on the surface (the bottom surface in FIG. 3B) of the silicon substrate 310. In the discharge port forming member 320, a plurality of pressure chambers 12 corresponding to a plurality of discharge elements 15 and a plurality of discharge ports 13 for discharging a liquid are each formed by photolithographic technique. Furthermore, in the silicon substrate 310, a common supply channel 18 and a common collection channel 19 are formed. In addition, in the silicon substrate 310, a supply connection channel 323 communicating between the common supply channel 18 and each pressure chamber 12 and a collection connection channel 324 communicating between the common collection channel 19 and each pressure chamber 12 are formed. In the configuration of the present embodiment, one discharge module 300 performs discharging of 2 types of liquids. That is, among the two discharge modules shown in FIG. 3A, the discharge module 300 located on the left side in the drawing discharges the first and second inks, and the discharge module 300 located on the right side in the drawing discharges the third and the reaction liquid. This combination is an example, and the ink and reaction liquid may be in any combination. A configuration in which one discharge module discharges one type of a liquid may be adopted, or a configuration in which one discharge module discharges 3 or more types of liquids may be adopted. Two discharge modules 300 do not need to discharge the same number of types of liquids. A configuration including one discharge module 300 may be adopted, or a configuration including 3 or more discharge modules 300 may be adopted. Furthermore, in the example shown in FIGS. 3A and 3B, two discharge port rows extending in the Y direction are formed for one type of a liquid. The pressure chamber 12, the common supply channel 18, and the common collection channel 19 are formed for each of a plurality of discharge ports 13 constituting each discharge port row.

A liquid supply port and a liquid collection port described later are formed on the rear surface (the top surface in FIG. 3B) side of the silicon substrate 310. The liquid supply port supplies a liquid from a liquid supply channel 48 to a plurality of common supply channels 18, and the liquid collection port collects a liquid in a liquid collection channel 49 from a plurality of common collection channels 19.

The liquid supply port and liquid collection port referred herein indicate openings for supply and collection of liquids during liquid circulation in the forward direction described later. That is, in liquid circulation in the forward direction, a liquid is supplied from the liquid supply port to each common supply channel 18, and a liquid is collected from each common collection channel 19 to the liquid collection port. However, liquid circulation in which a liquid flows in the reverse direction may also be performed. In this case, a liquid is supplied from the liquid collection port described above to the common collection channel 19, and a liquid is collected from the common supply channel 18 to the liquid supply port.

As shown in FIG. 3A, the rear surface (the top surface in FIG. 3A) of the discharge module 300 is adhesion-fixed to one surface (the bottom surface in FIG. 3A) of the first support member 4.

The first support member 4 is formed with a liquid supply channel 48 and a liquid collection channel 49 passing through from one surface to the other surface thereof. One opening of the liquid supply channel 48 communicates with the above-described liquid supply port of the silicon substrate 310, and the one opening of the liquid collection channel 49 communicates with the above-described liquid collection port of the silicon substrate 310. The liquid supply channel 48 and the liquid collection channel 49 are provided independently for each type of liquid.

A second support member 7 having openings 7a (see FIG. 2) for allowing the discharge modules 300 to insert therein is adhesion-fixed to one surface (the top surface in FIG. 3A) of the first support member 4.

The second support member 7 holds an electric wiring member 5 that is electrically connected to the discharge module 300. The electric wiring member 5 is a member for applying an electric signal for discharging a liquid to the discharge module 300. The electrical connection portion between the discharge module 300 and the electric wiring member 5 is sealed with a sealing material (not shown) and is protected from corrosion due to a liquid and external impact.

An electric contact substrate 6 is thermocompression bonded to the end portion 5a (see FIG. 2) of the electric wiring member 5 using an anisotropic conducting film (not shown) to electrically connect between the electric wiring member 5 and the electric contact substrate 6. The electric contact substrate 6 includes an external-signal input terminal (not shown) for receiving an electric signal from the liquid discharge apparatus 50.

Furthermore, a joint member 8 (FIG. 3A) is provided between the first support member 4 and the circulation unit 54. The joint member 8 is formed with a supply port 88 and a collection port 89 for each type of liquid. The supply port 88 and the collection port 89 communicate between the liquid supply channel 48 and the liquid collection channel 49 of the first support member 4 and a flow channel formed in the circulation unit 54. In FIG. 3A, the supply port 88A and the collection port 89A correspond to a first ink, and the supply port 88B and the collection port 89B correspond to a second ink. The supply port 88C and the collection port 89C correspond to a third ink, and the supply port 88D and the collection port 89D correspond to a reaction liquid.

The opening at one end portion of each of the liquid supply channel 48 and the liquid collection channel 49 of the first support member 4 has a small opening area adjusted to the liquid supply port and the liquid collection port in the silicon substrate 310. In contrast, the opening of the other end portion of each of the liquid supply channel 48 and the liquid collection channel 49 of the first support member 4 has a shape with an enlarged opening area that is the same as the large opening area of the joint member 8 formed so as to adjust the flow channel of the circulation unit 54. In such a configuration, it is possible to suppress an increase in the flow channel resistance to the liquid collected from each collection channel. However, the shapes of the openings of one end portion and the other end portion of each of the liquid supply channel 48 and the liquid collection channel 49 are not limited to the above examples.

In the liquid discharge head 1 having the above configuration, the liquid supplied to the circulation unit 54 passes through the supply port 88 of the joint member 8 and the liquid supply channel 48 of the first support member 4 and flows into a common supply channel 18 through the liquid supply port of the discharge module 300. Subsequently, the liquid flows into a pressure chamber 12 from the common supply channel 18 through the supply connection channel 323, and part of the liquid flowed into the pressure chamber is discharged from a discharge port 13 by the drive of a discharge element 15. The remaining liquid not discharged flows out from the pressure chamber 12, passes through the collection connection channel 324 and the common collection channel 19, and flows into the liquid collection channel 49 of the first support member 4 through the liquid collection port. The liquid flowed into the liquid collection channel 49 then flows into a circulation unit 54 through the collection port 89 or the joint member 8 and is collected.

### Component of Circulation Unit

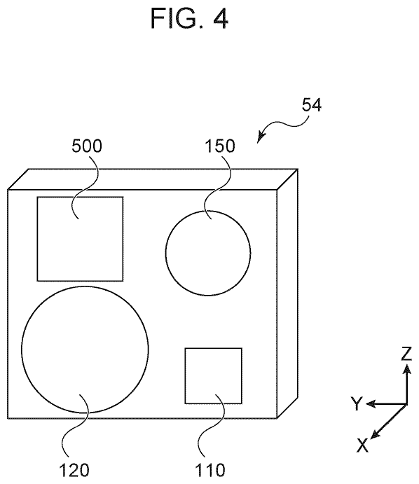

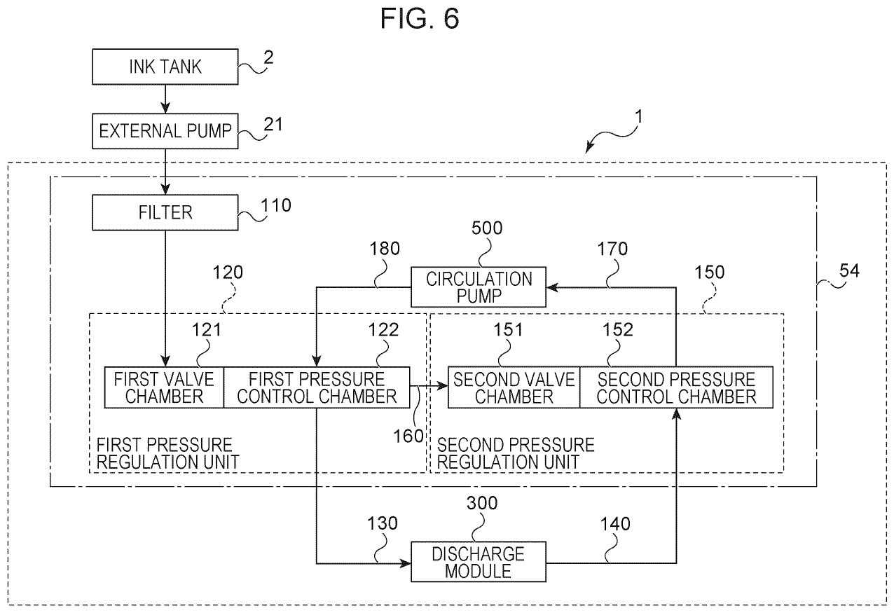

FIG. 4 is an external appearance schematic view of one circulation unit 54 corresponding to one type of a liquid that is applied to the printing apparatus of the present embodiment. The circulation unit 54 may include, in addition to the circulation pump 500, a filter 110, a first pressure regulation unit 120, and a second pressure regulation unit 150. These components are connected to each flow channel as shown in FIGS. 5 and 6 and constitute a circulation path that performs supply and collection of a liquid for the discharge module 300 in the liquid discharge head 1.

### Circulation Path in Liquid Discharge Head

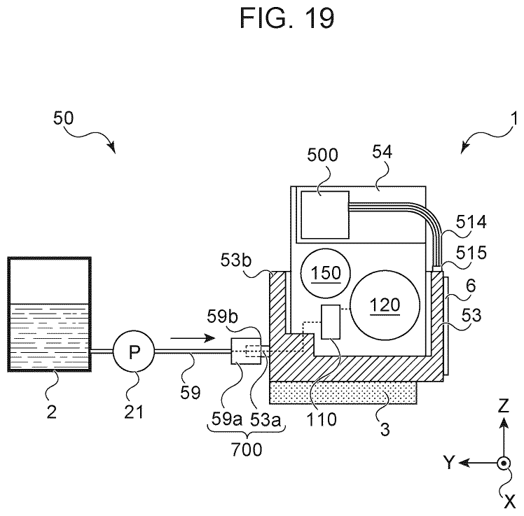

FIG. 5 is a vertical sectional view schematically illustrating a circulation path, for one type of a liquid (an ink of one color or a reaction liquid), constituted in the liquid discharge head 1. In order to more clearly explain the circulation path, the relative position of each component (such as the first pressure regulation unit 120, the second pressure regulation unit 150, and the circulation pump 500) in FIG. 5 is simplified. Accordingly, the relative position of each component is different from the configuration in FIG. 19 described later. FIG. 6 is a block diagram schematically illustrating the circulation path shown in FIG. 5. As shown in FIGS. 5 and 6, the first pressure regulation unit 120 includes a first valve chamber 121 and a first pressure control chamber 122. The second pressure regulation unit 150 includes a second valve chamber 151 and a second pressure control chamber 152. The first pressure regulation unit 120 is configured such that the control pressure is relatively higher than that of the second pressure regulation unit 150. In the present embodiment, circulation in a certain pressure range is realized in the circulation path by using these two pressure regulation units 120, 150. It is configured such that an ink flows in the pressure chamber 12 (discharge element 15) at a flow rate according to the difference between the pressures in the first pressure regulation unit 120 and the second pressure regulation unit 150. The circulation path in the liquid discharge head 1 and the flow of a liquid in the circulation path will now be described with reference to FIGS. 5 and 6. The arrows in each drawing indicates the direction in which a liquid flows.

The connection status of each component in the liquid discharge head 1 will be described.

An external pump 21 that sends the liquid stored in an ink tank 2 (FIG. 6) disposed outside the liquid discharge head 1 to the liquid discharge head 1 is connected to a circulation unit 54 through the supply tube 59 (FIG. 1). The flow channel (inlet flow channel) located upstream of the circulation unit 54 is provided with a filter 110. The liquid supply path (inlet flow channel) located downstream of the filter 110 is connected to the first valve chamber 121 of the first pressure regulation unit 120. The first valve chamber 121 communicates with the first pressure control chamber 122 through a communication port 191A that can be opened and closed by the valve 190A shown in FIG. 5. The inlet flow channel is a flow channel flowing into the liquid discharge head 1 for supplying the liquid in the ink tank 2 disposed outside the liquid discharge head 1 to the pressure chamber 12.

The first pressure control chamber 122 is connected to a supply channel 130, a bypass flow channel 160, and a pump outlet channel 180 of the circulation pump 500. The supply channel 130 is connected to the common supply channel 18 through the above-described liquid supply port provided to the discharge module 300. The bypass flow channel 160 is connected to a second valve chamber 151 provided in the second pressure regulation unit 150. The second valve chamber 151 communicates with a second pressure control chamber 152 through a communication port 191B that is opened and closed by a valve 190B shown in FIG. 5. FIGS. 5 and 6 show an example in which one end of the bypass flow channel 160 is connected to the first pressure control chamber 122 of the first pressure regulation unit 120, and the other end of the bypass flow channel 160 is connected to the second valve chamber 151 of the second pressure regulation unit 150. One end of the bypass flow channel 160 may be connected to the supply channel 130, and the other end of the bypass flow channel may be connected to the second valve chamber 151.

The second pressure control chamber 152 is connected to a collection channel 140. The collection channel 140 is connected to a common collection channel 19 through the above-described liquid collection port provided in the discharge module 300. Furthermore, the second pressure control chamber 152 is connected to the circulation pump 500 through a pump inlet channel 170. In FIG. 5, 170a indicates the inlet port of the pump inlet channel 170.

The flow of a liquid in the liquid discharge head 1 having the above-described configuration will be then described. As shown in FIG. 6, the liquid stored in the ink tank 2 is pressurized by the external pump 21 disposed in the liquid discharge apparatus 50 and supplied to the circulation unit 54 of the liquid discharge head 1 as a positive pressure liquid flow.

The liquid supplied to the circulation unit 54 passes through a filter 110 to remove foreign substances such as dust and air bubbles and then flows into a first valve chamber 121 provided in the first pressure regulation unit 120. Although the pressure of the liquid is decreased by pressure loss when passing through the filter 110, the liquid pressure at this stage is in a positive pressure state. Subsequently, when the valve 190A is in the open state, the liquid flowed into the first valve chamber 121 passes through the communication port 191A and flows into the first pressure control chamber 122. The liquid flowed into the first pressure control chamber 122 switches from the positive pressure state to a negative pressure state by the pressure loss when passing through the communication port 191A.

The flow of a liquid in the circulation path will be then described. The circulation pump 500 operates to send the liquid sucked from the pump inlet channel 170 on the upstream side to the pump outlet channel 180 on the downstream side. Accordingly, the liquid supplied to the first pressure control chamber 122 flows into the supply channel 130 and the bypass flow channel 160 together with the liquid sent from the pump outlet channel 180 by driving the pump. Although the details will be described later, in the present embodiment, as a circulation pump that can send a liquid, a piezoelectric diaphragm pump using a piezoelectric element attached to a diaphragm as the driving source is used. The piezoelectric diaphragm pump is a pump that sends a liquid by applying a driving voltage to the piezoelectric element to change the volume of the pump chamber and thereby alternately move two check valves by pressure variation.

The liquid flowed into the supply channel 130 passes through the common supply channel 18 and flows into the pressure chamber 12 through the liquid supply port of the discharge module 300, and part of the liquid is discharged from the discharge port 13 by drive (heat generation) of the discharge element 15. The remaining liquid not used in the discharge flows in the pressure chamber 12, passes through the common collection channel 19, and then flows into the collection channel 140 connected to the discharge module 300. The liquid flowed into the collection channel 140 flows into the second pressure control chamber 152 of the second pressure regulation unit 150.

In contrast, the liquid flowed into the bypass flow channel 160 from the first pressure control chamber 122 flows into a second valve chamber 151, then passes through the communication port 191B, and flows into the second pressure control chamber 152. The liquid flowed into the second pressure control chamber 152 through the bypass flow channel 160 and the liquid collected from the collection channel 140 are sucked in the circulation pump 500 through the pump inlet channel 170 by the drive of the circulation pump 500. The liquid sucked in the circulation pump 500 is sent to the pump outlet channel 180 and flows into the first pressure control chamber 122 again. After that, the liquid flowed into the second pressure control chamber 152 from the first pressure control chamber 122 through the supply channel 130 and then through the discharge module 300 and the liquid flowed into the second pressure control chamber 152 through the bypass flow channel 160 flow into the circulation pump 500. The liquids are then sent from the circulation pump 500 to the first pressure control chamber 122. Thus, circulation of a liquid in a circulation path is performed.

As described above, in the present embodiment, it is possible to circulate a liquid along a circulation path formed in the liquid discharge head 1 by the circulation pump 500. Accordingly, it is possible to suppress thickening of the liquid and accumulation of precipitation components of the colorant liquid in the discharge module 300, and it is possible to maintain the fluidity of a liquid in the discharge module 300 and the good status of the discharge characteristics in the discharge port.

The circulation path in the present embodiment adopts a configuration that completes within the liquid discharge head 1. Accordingly, the length of the circulation path can be significantly shortened compared when a liquid is circulated between an ink tank 2 disposed outside a liquid discharge head and the liquid discharge head 1, and the volume in the circulation path can be reduced. Consequently, the circulation of a liquid can be performed with a small size circulation pump such as a piezoelectric pump.

Furthermore, the connection channel of the liquid discharge head 1 and the ink tank 2 is configured so as to include only a flow channel for supplying a liquid. That is, a configuration that does not require a flow channel for collecting a liquid from the liquid discharge head 1 to the ink tank 2 is adopted. Consequently, it is sufficient to provide only a tube for liquid supply in connection between the ink tank 2 and the liquid discharge head 1, and a tube for liquid collection is not required. Accordingly, the inside of the liquid discharge apparatus 50 can have a simple configuration in which the number of tubes is decreased, and downsizing of the whole apparatus can be achieved. Furthermore, the decrease in the number of tubes can reduce the pressure variation of a liquid caused by oscillation of the tubes due to main scanning of the liquid discharge head 1. The oscillation of the tubes during main scanning of the liquid discharge head 1 becomes a driving load of a carriage motor that drives the carriage 60. Consequently, the decrease in the number of tubes reduces the driving load of the carriage motor, and it becomes possible to simplify the main scanning mechanism including the carriage motor. Furthermore, since there is no need to collect a liquid from the liquid discharge head to the ink tank, it is also possible to decrease the size of the external pump 21. Thus, according to the present embodiment, while configuring such that a liquid is allowed to circulate in the liquid discharge apparatus 50, downsizing and cost reduction can be realized.

The flow rate (circulation flow rate) for circulating a reaction liquid is preferably 1.0 mL/min or more and 10.0 mL/min or less and further preferably 2.0 mL/min or more and 5.0 mL/min or less.

### Pressure Regulation Unit

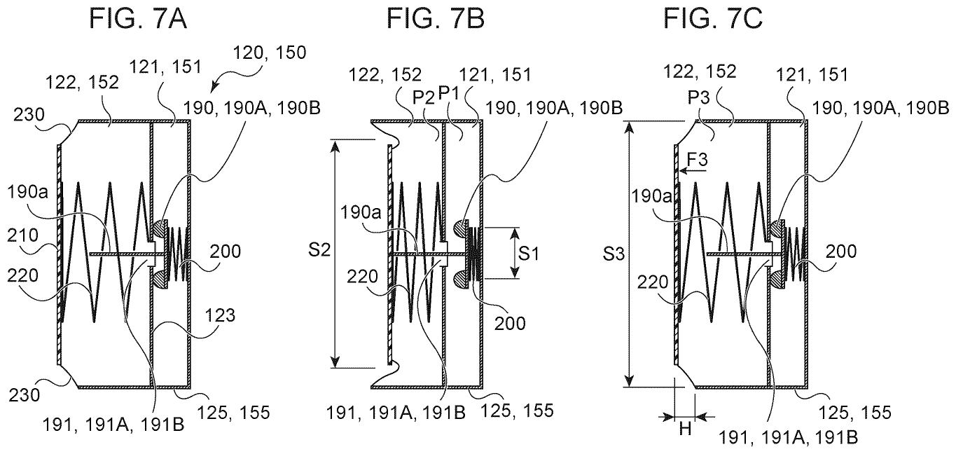

FIGS. 7A, 7B, and 7C are diagrams showing examples of the pressure regulation unit. With reference to FIGS. 7A to 7C, the configurations and functions of pressure regulation units (the first pressure regulation unit 120 and the second pressure regulation unit 150) built in the above-described liquid discharge head 1 will be described in more detail. The first pressure regulation unit 120 and the second pressure regulation unit 150 have substantially the same configuration. Accordingly, in the following, the first pressure regulation unit 120 will be described as an example, and regarding the second pressure regulation unit 150, only the reference numerals of the parts corresponding to the first pressure regulation unit are shown in FIGS. 7A to 7C. In the second pressure regulation unit 150, the first valve chamber 121 that will be described below is replaced by the second valve chamber 151, and the first pressure control chamber 122 is replaced by the second pressure control chamber 152.

The first pressure regulation unit 120 includes a first valve chamber 121 and a first pressure control chamber 122 formed in a cylindrical housing 125. The first valve chamber 121 and the first pressure control chamber 122 are separated from each other with a partition 123 disposed in the cylindrical housing 125. However, the first valve chamber 121 communicates with the first pressure control chamber 122 through a communication port 191 formed in the partition 123. The first valve chamber 121 is provided with a valve 190 that switches communication and shutdown between the first valve chamber 121 and the first pressure control chamber 122 at the communication port 191. The valve 190 is held by a valve spring 200 at a position facing the communication port 191 and is configured to be brought into close contact with the partition 123 by the biasing force of the valve spring 200. When the valve 190 is in close contact with the partition 123, the flow of a liquid in the communication port 191 is disconnected. In order to enhance the closeness with the partition 123, the contact portion of the valve 190 with the partition 123 may be formed of an elastic material. A valve shaft 190a that is inserted in the communication port 191 is provided in a protruding state at the central portion of the valve 190. The valve 190 is separated from the partition 123 by pressing this valve shaft 190a against the biasing force of the valve spring 200, and it becomes possible that a liquid flows in the communication port 191. Hereinafter, a state in which the flow of a liquid through the communication port 191 is blocked by the valve 190 is referred to as a “closed state”, and a state in which a liquid flows through the communication port 191 is referred to as an “open state”.

The opening portion of the cylindrical housing 125 is occluded by a flexible member 230 and a pressing plate 210. The flexible member 230, the pressing plate 210, the surrounding wall of the housing 125, and the partition 123 form the first pressure control chamber 122. The pressing plate 210 is configured so as to be displaceable as the flexible member 230 is displaced. The materials of the pressing plate 210 and the flexible member 230 are not particularly limited. For example, the pressing plate 210 can be formed of a resin molded product, and the flexible member 230 can be formed of a resin film. In this case, the pressing plate 210 can be fixed to the flexible member 230 by thermal welding.

A pressure adjusting spring 220 (biasing member) is disposed between the pressing plate 210 and the partition 123. The pressing plate 210 and the flexible member 230 are energized by the biasing force of the pressure adjusting spring 220 in the direction in which the inner volume of the first pressure control chamber 122 is increased as shown in FIG. 7A.

When the pressure in the first pressure control chamber 122 is decreased, the pressing plate 210 and the flexible member 230 displace so that the inner volume of the first pressure control chamber 122 is decreased against the pressure of the pressure adjusting spring 220. When the inner volume of the first pressure control chamber 122 is decreased to a certain volume, the pressing plate 210 abuts against the valve shaft 190a of the valve 190. Subsequently, when the inner volume of the first pressure control chamber 122 is decreased, the valve 190 moves together with the valve shaft 190a against the biasing force of the valve spring 200 and is separated from the partition 123. Consequently, the communication port 191 becomes the open state (the state shown in FIG. 7B).

In the present embodiment, the connection in the circulation path is set such that the pressure in the first valve chamber 121 when the communication port 191 is in the open state is higher than the pressure in the first pressure control chamber 122.

Consequently, when the communication port 191 becomes the open state, a liquid flows into the first pressure control chamber 122 from the first valve chamber 121. This liquid flow displaces the flexible member 230 and the pressing plate 210 such that the inner volume of the first pressure control chamber 122 is increased. As a result, the pressing plate 210 is separated from the valve shaft 190a of the valve 190, the valve 190 is brought into close contact with the partition 123 by the biasing force of the valve spring 200, and the communication port 191 becomes the closed state (the state shown in FIG. 7C).

Thus, in the first pressure regulation unit 120 in the present embodiment, when the pressure in the first pressure control chamber 122 is decreased to a certain pressure or less (for example, when the negative pressure becomes stronger), the liquid flows into the first pressure control chamber 122 from the first valve chamber 121 through the communication port 191. Consequently, it is configured such that the pressure of the first pressure control chamber 122 does not decrease further. Accordingly, the first pressure control chamber 122 is controlled so as to maintain the pressure within a certain range.

The pressure in the first pressure control chamber 122 will be then described in more detail.

As described above, it is considered an open state of the communication port 191 (the state shown in FIG. 7B) in which the flexible member 230 and the pressing plate 210 are displaced in response to the pressure in the first pressure control chamber 122, and the pressing plate 210 abuts against the valve shaft 190a. On this occasion, the relation of the force acting on the pressing plate 210 is represented by the following equation 1:

$$P 2 \times S 2 + F 2 + ( P 1 - P 2 ) \times S 1 + F 1 = 0. \qquad Equation 1$$

Furthermore, organization of the equation 1 regarding P2 gives the following:

$$P 2 = - ( F 1 + F 2 + P 1 \times S 1 ) / ( S 2 - S 1 ) . \qquad Equation 2$$

P1: pressure (gauge pressure) of first valve chamber 121;
P2: pressure (gauge pressure) of first pressure control chamber 122;
F1: spring force of valve spring 200;
F2: spring force of pressure adjusting spring 220;
S1: pressure receiving area of valve 190; and
S2: pressure receiving area of pressing plate 210.

Here, the direction in which the spring force F1 of the valve spring 200 and the spring force F2 of the pressure adjusting spring 220 press the valve 190 and the pressing plate 210 (the left direction in FIGS. 7A to 7C) are defined as positive. It is configured such that the pressure P1 in the first valve chamber 121 and the pressure P2 in the first pressure control chamber 122 have a relationship of P1≥P2.

The pressure P2 in the first pressure control chamber 122 when the communication port 191 becomes the open state is determined by the equation 2, and it is configured such that when the communication port 191 becomes the open state, a relationship of P1≥P2 is established. Consequently, a liquid flows into the first pressure control chamber 122 from the first valve chamber 121. As a result, the pressure P2 in the first pressure control chamber 122 does not decrease further, and the pressure P2 is maintained within a certain range.

In contrast, as shown in FIG. 7C, when the pressing plate 210 is in non-contact with the valve shaft 190a and the communication port 191 becomes the closed state, the relation of the force acting on the force pressing plate 210 is represented by the equation 3:

$$P 3 \times S 3 + F 3 = 0. \qquad Equation 3$$

Here, organization of the equation 3 regarding P3 gives the following:

$$P 3 = - F 3 / S 3. \qquad Equation 4$$

F3: spring force of the pressure adjusting spring 220 when the pressing plate 210 and the valve shaft 190a are in a non-contact state;
P3: pressure (gauge pressure) of the first pressure control chamber 122 when the pressing plate 210 and the valve shaft 190a are in a non-contact state; and
S3: pressure receiving area of the pressing plate 210 when the pressing plate 210 and the valve 190 are in a non-contact state.

Here, FIG. 7C shows a state in which the pressing plate 210 and the flexible member 230 are displaced to the right direction in the drawing up to the limit of possible displacement. The pressure P3 in the first pressure control chamber 122, the spring force F3 of the pressure adjusting spring 220, and the pressure receiving area S3 of the pressing plate 210 change according to the amount of displacement until the pressing plate 210 and the flexible member 230 are displaced to the state shown in FIG. 7C. Specifically, when the pressing plate 210 and the flexible member 230 are on the right side as shown in FIG. 7B compared to them in FIG. 7C, the pressure receiving area S3 of the pressing plate 210 is decreased, and the spring force F3 of the pressure adjusting spring 220 is increased. As a result, the pressure P3 in the first pressure control chamber 122 is decreased by the relationship of the equation 4. Accordingly, during the change from the state shown in FIG. 7B to the state shown in FIG. 7C, the pressure in the first pressure control chamber 122 gradually increases (that is, the negative pressure becomes weaker and approaches the positive pressure side) according to the equations 2 and 4. That is, the pressing plate 210 and the flexible member 230 gradually displace to the left direction from the state in which the communication port 191 is in the open state, and the pressure in the first pressure control chamber gradually increases until the inner volume of the first pressure control chamber 122 finally reaches the limit of possible displacement. That is, the negative pressure weakens.

### Circulation Pump

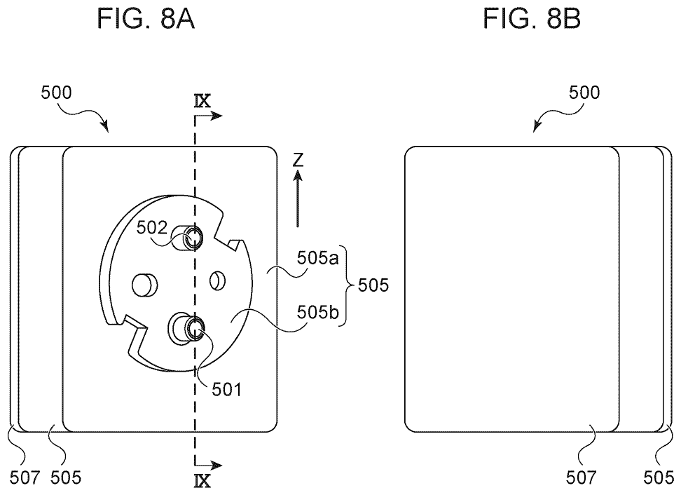

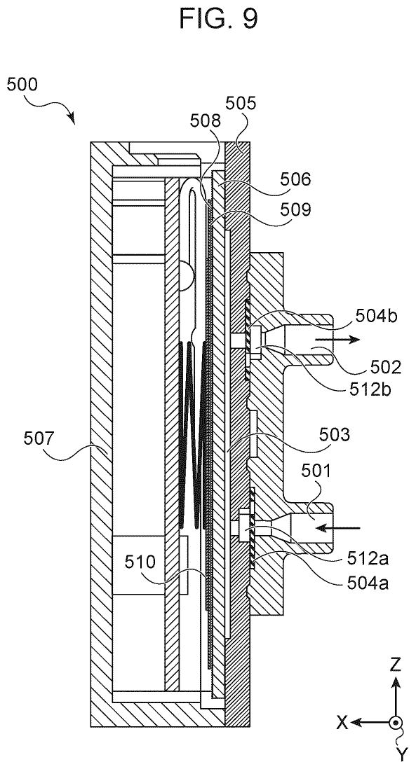

The configuration and function of the circulation pump 500 built in the above-described liquid discharge head 1 will be then described in detail with reference to FIGS. 8A, 8B, and 9.

FIGS. 8A and 8B are external appearance perspective views of the circulation pump 500. FIG. 8A is an external appearance perspective view illustrating the front side of the circulation pump 500, and FIG. 8B is an external appearance perspective view illustrating the back side of the circulation pump 500.

The outer shell of the circulation pump 500 is configured of a pump housing 505 and a cover 507 fixed to the pump housing 505. The pump housing 505 is configured of a housing main body 505a and a flow channel connecting member 505b adhesion-fixed to the outer surface of the housing main body 505a. A pair of through holes communicating with each other is provided in each of the housing main body 505a and the flow channel connecting member 505b at two different positions. A pair of through holes provided at one position forms a pump supply hole 501, and a pair of through holes provided at the other position forms a pump discharge hole 502. The pump supply hole 501 is connected to the pump inlet channel 170 that is connected to the second pressure control chamber 152, and the pump discharge hole 502 is connected to the pump outlet channel 180 that is connected to the first pressure control chamber 122. The liquid supplied through the pump supply hole 501 passes through a pump chamber 503 described later (see FIG. 9) and is discharged through the pump discharge hole 502.

FIG. 9 is a line IX-IX cross-sectional view of the circulation pump 500 shown in FIG. 8A. A diaphragm 506 is bonded to the inner surface of the pump housing 505, and a pump chamber 503 is formed between this diaphragm 506 and the recessed portion formed on the inner surface of the pump housing 505. The pump chamber 503 communicates with the pump supply hole 501 and the pump discharge hole 502 formed in the pump housing 505. A check valve 504a is provided at the middle portion of the pump supply hole 501, and a check valve 504b is provided at the middle portion of the pump discharge hole 502. Specifically, the check valve 504a is arranged such that it can move to the left in the drawing in the space 512a that is partially formed at the middle portion of the pump supply hole 501. The check valve 504b is arranged such that it can move to the right in the drawing in the space 512B that is partially formed at the middle portion of the pump discharge hole 502.

When the pressure in the pump chamber 503 is decreased by an increase in the volume of the pump chamber 503 by displacement of the diaphragm 506, the check valve 504a is separated from the opening of the pump supply hole 501 in the space 512a (that is, moves to the left in the drawing). The check valve 504a is separated from the opening of the pump supply hole 501 in the space 512a and becomes the open state allowing the liquid in the pump supply hole 501 to flow. The check valve 504a is brought into close contact with the wall around the opening of the pump supply hole 501 by pressurization of the pump chamber 503 due to a decrease in the volume of the pump chamber 503 by displacement of the diaphragm 506. Consequently, the check valve 504a becomes the closed state in which the flow of a liquid in the pump supply hole 501 is blocked.

In contrast, the check valve 504b is brought into close contact with the wall around the opening of the pump housing 505 by reducing the pressure in the pump chamber 503 and becomes the closed state in which the flow of a liquid in the pump discharge hole 502 is blocked. When a pressure is applied to the pump chamber 503, the check valve 504b is separated from the opening of the pump housing 505 and moves to the space 512b side (that is, moves to the right in the drawing), and the liquid can flow in the pump discharge hole 502.

The check valves 504a, 504b may be made of any materials that can be deformed in response to the pressure in the pump chamber 503, and can be formed of, for example, elastic materials such as EPDM and elastomers or films or thin plates of polypropylene and so on. However, the materials are not limited thereto.

As described above, the pump chamber 503 is formed by bonding the pump housing 505 and the diaphragm 506. Accordingly, the pressure in the pump chamber 503 is changed by deformation of the diaphragm 506. For example, the diaphragm 506 is displaced to the pump housing 505 side (in the drawing, displaced to the right side) to decrease the volume of the pump chamber 503, and the pressure in the pump chamber 503 is thereby increased. Consequently, the check valve 504b arranged so as to face the pump discharge hole 502 becomes the open state, the liquid in the pump chamber 503 is discharged. On this occasion, since the check valve 504a arranged so as to face the pump supply hole 501 is brought into close contact with the wall around the pump supply hole 501, the backflow of a liquid from the pump chamber 503 to the pump supply hole 501 is prevented.

In contrast, when the diaphragm 506 is displaced to a direction in which the pump chamber 503 is expanded, the pressure in the pump chamber 503 decreases. Consequently, the check valve 504a arranged so as to face the pump supply hole 501 becomes the open state to supply the liquid to the pump chamber 503. On this occasion, the check valve 504b arranged in the pump discharge hole 502 is brought into close contact with the wall around the opening formed in the pump housing 505 to occlude the opening. Consequently, the backflow of the liquid from the pump discharge hole 502 to the pump chamber 503 is prevented.

Thus, in the circulation pump 500, the diaphragm 506 is deformed to change the pressure in the pump chamber 503, and thereby suction and discharge of a liquid are performed. On this occasion, if bubbles permeate into the pump chamber 503, the change in the pressure in the pump chamber 503 becomes smaller due to expansion and contraction of the bubbles, even when the diaphragm 506 is displaced, to decrease the liquid feeding amount. Accordingly, the pump chamber 503 is arranged to be parallel to the gravity such that the bubbles permeated into the pump chamber 503 tend to be collected at the top of the pump chamber 503, and the pump discharge hole 502 is arranged above the center of the pump chamber 503. Consequently, it is possible to improve the ability to discharge bubbles inside the pump, and it is possible to stabilize the flow rate.

### Flow of Liquid in Liquid Discharge Head

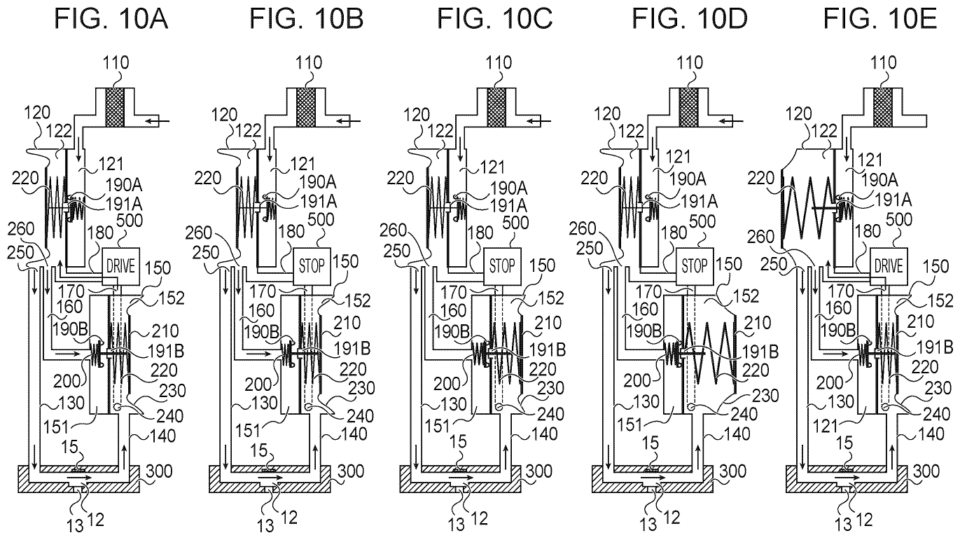

FIGS. 10A to 10E are diagrams for explaining the flow of a liquid in a liquid discharge head. With reference to FIGS. 10A to 10E, circulation of a liquid in the liquid discharge head 1 will be described. In order to more clearly describe the liquid circulation path, the relative positions of the components (such as the first pressure regulation unit 120, the second pressure regulation unit 150, and the circulation pump 500) in FIGS. 10A to 10E are simplified. Accordingly, the relative positions of the components are different from the configuration shown in FIG. 19 described later. FIG. 10A schematically shows the flow of a liquid when printing operation is performed by discharging the liquid from the discharge port 13. The arrows in the drawings indicate the liquid flow. In the present embodiment, when printing operation is performed, both the external pump 21 and the circulation pump 500 start to be driven. In the state of not performing printing operation, the external pump 21 and the circulation pump 500 may be driven. The external pump 21 and the circulation pump 500 may be driven in connection with each other but may be driven separately and independently.

During printing operation, the circulation pump 500 is in the state of “ON” (driving state), and the liquid flowed out from the first pressure control chamber 122 flows into the supply channel 130 and the bypass flow channel 160. The liquid flowed into the supply channel 130 passes through the discharge module 300 and then flows into the collection channel 140, and is then supplied to the second pressure control chamber 152.

On the other hand, the liquid flowed into the bypass flow channel 160 from the first pressure control chamber 122 flows into the second pressure control chamber 152 through the second valve chamber 151. The liquid flowed into the second pressure control chamber 152 passes through the pump inlet channel 170, the circulation pump 500, and the pump outlet channel 180 and then flows into the first pressure control chamber 122 again. On this occasion, the control pressure by the first valve chamber 121 is set to be higher than the control pressure in the first pressure control chamber 122 based on the relationship of the above-described equation 2. Accordingly, the liquid in the first pressure control chamber 122 is supplied to the discharge module 300 again through the supply channel 130, without flowing into the first valve chamber 121. The liquid flowed into the discharge module 300 passes through the collection channel 140, the second pressure control chamber 152, the pump inlet channel 170, the circulation pump 500, and the pump outlet channel 180 and then flows into the first pressure control chamber 122 again.

As described above, liquid circulation that is completed within the liquid discharge head 1 is performed.

In the liquid circulation above, the circulation amount (flow rate) of the liquid in the discharge module 300 is determined by the differential pressure between the control pressures of the first pressure control chamber 122 and the second pressure control chamber 152. This differential pressure is set to a circulation amount that can suppress thickening of the liquid in the vicinity of the discharge port in the discharge module 300. A liquid in the amount consumed by printing is supplied to the first pressure control chamber 122 from the ink tank 2 through the filter 110 and the first valve chamber 121. The mechanism for supplying the consumed liquid will be described in detail. The liquid in the circulation path is decreased by the amount of the liquid consumed by printing, and thereby the pressure in the first pressure control chamber is decreased. As a result, the liquid in the first pressure control chamber 122 is also decreased. The decrease of the liquid in the first pressure control chamber 122 causes a decrease in the inner volume of the first pressure control chamber 122. By this decrease in the inner volume of the first pressure control chamber 122, the communication port 191A becomes the open state, and the liquid is supplied to the first pressure control chamber 122 from the first valve chamber 121. A pressure loss is generated in this supplied liquid when the liquid passes through the communication port 191A from the first valve chamber 121, and the liquid flows into the first pressure control chamber 122 to switch the liquid from a positive pressure state to a negative pressure state. The liquid then flows into the first pressure control chamber 122 from the first valve chamber 121 to increase the pressure in the first pressure control chamber, which increases the inner volume of the first pressure control chamber, resulting in the closed state of the communication port 191A. Thus, the open state and the closed state of the communication port 191A are repeated according to the consumption of a liquid. When the liquid is not consumed, the communication port 191A is maintained in the closed state.

FIG. 10B schematically shows the flow of a liquid immediately after the end of the printing operation and the change to the state of “OFF” (stopped state) of the circulation pump 500. At the time when the printing operation ends and the circulation pump 500 is switched to “OFF”, the pressure in the first pressure control chamber 122 and the pressure in the second pressure control chamber 152 are both control pressures during printing operation. Consequently, the movement of the liquid occurs as shown in FIG. 10B depending on the differential pressure between the pressure of the first pressure control chamber 122 and the pressure of the second pressure control chamber 152. Specifically, a liquid is supplied to the discharge module 300 from the first pressure control chamber 122 through the supply channel 130, and then a flow of the liquid passing through the collection channel 140 and reaching the second pressure control chamber 152 continuously occurs. In addition, a flow of a liquid from the first pressure control chamber 122 passing through the bypass flow channel 160 and the second valve chamber 151 and reaching the second pressure control chamber 152 also continuously occurs.

The liquid is supplied to the first pressure control chamber 122 from the ink tank 2 through the filter 110 and the first valve chamber 121 by the amount of the liquid moved from the first pressure control chamber 122 to the second pressure control chamber 152 by the above-described flows of the liquid. Consequently, the inner volume of the first pressure control chamber 122 is maintained constant. From the relationship with the above-described equation 2, when the inner volume of the first pressure control chamber 122 is constant, the spring force F1 of the valve spring 200, the spring force F2 of the pressure adjusting spring 220, the pressure receiving area S1 of the valve 190, and the pressure receiving area S2 of the pressing plate 210 are maintained constant. Accordingly, the pressure in the first pressure control chamber 122 is determined in response to the change in the pressure (gauge pressure) P1 in the first valve chamber 121. Therefore, when the pressure P1 in the first valve chamber 121 does not change, the pressure P2 in the first pressure control chamber 122 is maintained at the same pressure as the control pressure during printing operation.

In contrast, the pressure in the second pressure control chamber 152 changes over time in response to the change in the inner volume due to the inflow of a liquid from the first pressure control chamber 122. Specifically, the pressure in the second pressure control chamber 152 changes according to the equation 2 during from the state shown in FIG. 10B to the state in which the second valve chamber 151 and the second pressure control chamber 152 are not communicated with each other due to the closed state of the communication port 191 as shown in FIG. 10C. Subsequently, the pressing plate 210 and the valve shaft 190a are brought into non-contact with each other, and the communication port 191 becomes the closed state. As shown in FIG. 10D, the liquid flows into the second pressure control chamber 152 from the collection channel 140. This liquid inflow displaces the pressing plate 210 and the flexible member 230, and the pressure in the second pressure control chamber 152 changes according to the equation 4 until the inner volume of the second pressure control chamber 152 reaches the maximum. That is, the pressure increases.

When the state is changed to that shown in FIG. 10C, a flow of the liquid, from the first pressure control chamber 122 to the second pressure control chamber 152 through the bypass flow channel 160 and the second valve chamber 151, does not occur. Accordingly, only a flow of the liquid in the first pressure control chamber 122 is supplied to the discharge module 300 through the supply channel 130 and then passes through the collection channel 140 and reaches the second pressure control chamber 152 occurs. As described above, movement of a liquid from the first pressure control chamber 122 to the second pressure control chamber 152 occurs in response to the difference between the pressure in the first pressure control chamber 122 and the pressure in the second pressure control chamber 152. Consequently, the movement of the liquid stops when the pressure in the second pressure control chamber 152 and the pressure in the first pressure control chamber 122 become the same.

In the state in which the pressure in the second pressure control chamber 152 is equal to the pressure in the first pressure control chamber 122, the second pressure control chamber 152 is expanded to the state shown in FIG. 10D. When the second pressure control chamber 152 is expanded as shown in FIG. 10D, in the second pressure control chamber 152, a reservoir portion that can store a liquid is formed. The time for transition from the stop of the circulation pump 500 to the state shown in FIG. 10D may vary depending on the shape and size of the flow channel and the properties of the liquid, but is approximately 1 to 2 minutes. The liquid in the reservoir portion is supplied to the first pressure control chamber 122 by the circulation pump 500 by driving the circulation pump 500 from the state in which the liquid is stored in the reservoir portion shown in FIG. 10D. Consequently, as shown in FIG. 10E, the amount of the liquid in the first pressure control chamber 122 is increased, and the flexible member 230 and the pressing plate 210 displace to the expansion direction. When the circulation pump 500 is continuously driven, as shown in FIG. 10A, the condition in the circulation path changes.

In the description above, although FIG. 10A has been explained as an example of printing operation, circulation of a liquid may be performed without printing operation as described above. Also in such a case, a flow of the liquid as shown in FIGS. 10A to 10E occurs in response to operation and stopping of the circulation pump 500.

As described above, the present embodiment uses an example in which the communication port 191B in the second pressure regulation unit 150 becomes the open state when the circulation pump 500 is driven to circulate a liquid and becomes the closed state when the circulation of the liquid stops, but is not limited thereto. The control pressure may be set such that the communication port 191B in the second pressure regulation unit 150 is in the closed state even when the circulation pump 500 is driven to circulate a liquid. Hereinafter, the bypass flow channel 160 will be specifically described together with its function.

The bypass flow channel 160 connecting between the first pressure regulation unit 120 and the second pressure regulation unit 150 is provided, for example, for preventing the discharge module 300 from being influenced by a negative pressure generated in the circulation path that is stronger than a predetermined value. The bypass flow channel 160 may be provided also for supplying a liquid to the pressure chamber 12 from both sides of the supply channel 130 and the collection channel 140.

An example in which the bypass flow channel 160 is provided for preventing the discharge module 300 from being influenced by a negative pressure stronger than a predetermined value will now be described. For example, the characteristics (e.g., viscosity) of a liquid may vary in response to a change in the environmental temperature. If the viscosity of a liquid changes, the pressure loss in the circulation path also changes. For example, if the viscosity of a liquid decreases, the pressure loss amount in the circulation path also decreases. As a result, the flow rate of the circulation pump 500 that is driven at a certain driving amount is increased to increase the flow rate flowing in the discharge module 300. At the same time, since the discharge module 300 is maintained at a constant temperature by a temperature control unit (not shown, described later), the viscosity of the liquid in the discharge module 300 remains constant even if the environmental temperature changes. The flow rate of the liquid flowing in the discharge module 300 increases while the viscosity of the liquid in the discharge module 300 does not change. Consequently, the negative pressure in the discharge module 300 is strengthened by the flow resistance. The negative pressure in the discharge module 300 thus gets stronger than a predetermined value to break the meniscus of the discharge port 13, and the outside air is drawn into the circulation path, resulting in a risk that normal discharge cannot be performed. Even if the meniscus is not broken, the negative pressure of the pressure chamber 12 becomes stronger than a predetermined value, which may affect the discharge.

Accordingly, in the present embodiment, the bypass flow channel 160 is formed in the circulation path. When the negative pressure becomes stronger than a predetermined value by providing the bypass flow channel 160, since the liquid also flows in the bypass flow channel 160, the pressure in the discharge module 300 can be maintained constant. Accordingly, for example, a control pressure may be set such that the communication port 191B in the second pressure regulation unit 150 maintains the closed state even during the driving of the circulation pump 500, and a control pressure in the second pressure regulation unit may be set such that when the negative pressure is stronger than a predetermined value, the communication port 191 of the second pressure regulation unit 150 becomes the open state. That is, the communication port 191B may be the closed state during the circulation pump 500 is being driven as long as the meniscus does not collapse even when the pump flow rate changes due to a change in the viscosity caused by environmental changes or a predetermined negative pressure is maintained.

An example in which the bypass flow channel 160 is provided for supplying a liquid to the pressure chamber 12 from both sides of the supply channel 130 and the collection channel 140 will now be described. The pressure variation in the circulation path can occur also by the discharge operation by the discharge element 15. This is because the discharge operation generates a force that draws a liquid into the pressure chamber.

The point at which the liquid to be supplied to the pressure chamber 12 is supplied from both sides, the supply channel 130 side and the collection channel 140 side, when continuing high duty printing will now be described. Although the definition of the duty may vary due to various conditions, here, the state in which one ink droplet of 4 pL is printed on a 1200 dpi grid is treated as 100%. High duty printing is, for example, printing at 100% duty.

When high duty printing is continued, the amount of the liquid flowing into the second pressure control chamber 152 from the pressure chamber 12 through the collection channel 140 is decreased. On the other hand, since the circulation pump 500 sends out a certain amount of the liquid, the balance between inflow and outflow in the second pressure control chamber 152 is disrupted, the liquid in the second pressure control chamber 152 is decreased, the negative pressure in the second pressure control chamber 152 becomes stronger, and the second pressure control chamber 152 is contracted. The amount of the liquid flowing into the second pressure control chamber 152 through the bypass flow channel 160 is increased by that the negative pressure in the second pressure control chamber 152 becomes stronger, and the second pressure control chamber 152 is stabilized in a state in which the outflow and inflow are balanced. Thus, as a result, the negative pressure in the second pressure control chamber 152 becomes stronger depending on the duty. As described above, in the configuration in which the communication port 191B is in the closed state during the operation of the circulation pump 500, the communication port 191B becomes the open state depending on the duty, and the liquid flows into the second pressure control chamber 152 from the bypass flow channel 160.

When further continuing high duty printing, the amount flowing into the second pressure control chamber 152 from the pressure chamber 12 through the collection channel 140 decreases, instead, the amount passing through the bypass flow channel 160 and flowing into the second pressure control chamber 152 from the communication port 191B increases. When this state further progresses, the amount of the liquid flowing into the second pressure control chamber 152 from the pressure chamber 12 through the collection channel 140 becomes zero, all the liquid that flows out to the circulation pump 500 becomes the liquid flowing into the second pressure control chamber 152 through the communication port 191B. When this state further progresses, this time, the liquid flows back into the pressure chamber 12 from the second pressure control chamber 152 through the collection channel 140. In this state, the liquid flowing out from the second pressure control chamber 152 to the circulation pump 500 and the liquid flowing out to the pressure chamber 12 pass through the bypass flow channel 160 and flow into the second pressure control chamber 152 from the communication port 191B. In this case, the pressure chamber 12 is filled with the liquid in the supply channel 130 and the liquid in the collection channel 140, and discharge is performed.

This backflow of the liquid occurring when the printing duty is high is a phenomenon caused by providing the bypass flow channel 160. In the above, although an example in which the communication port 191B in the second pressure regulation unit becomes the open state in response to the backflow of a liquid has been described, backflow of a liquid may occur when the communication port 191B in the second pressure regulation unit is in the open state. In addition, in a configuration not providing the second pressure regulation unit, the backflow of the liquid can occur by providing the bypass flow channel 160.

### Configuration of Discharge Unit

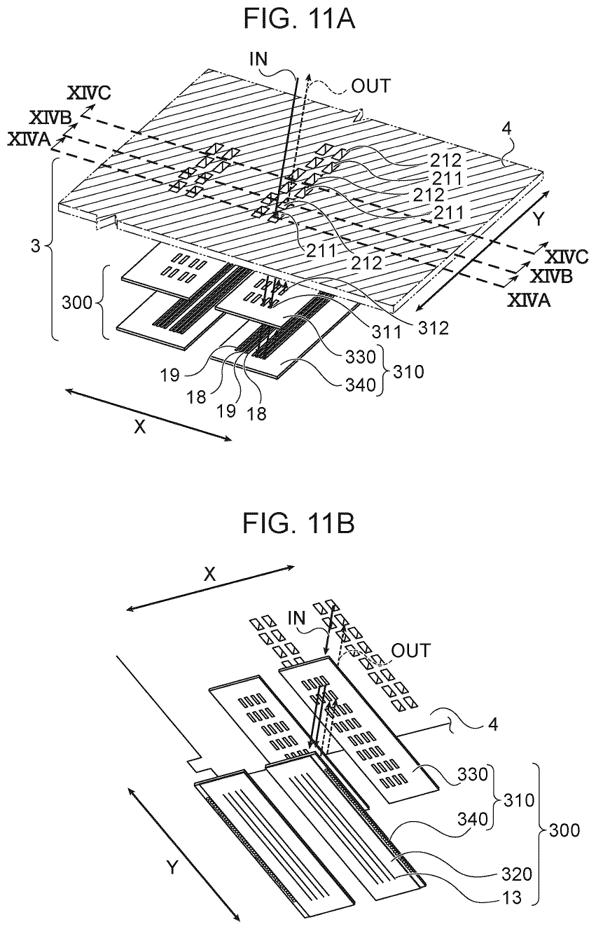

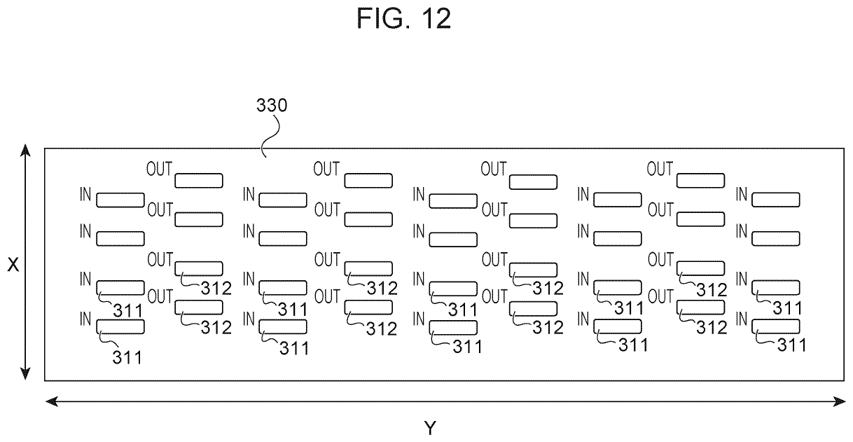

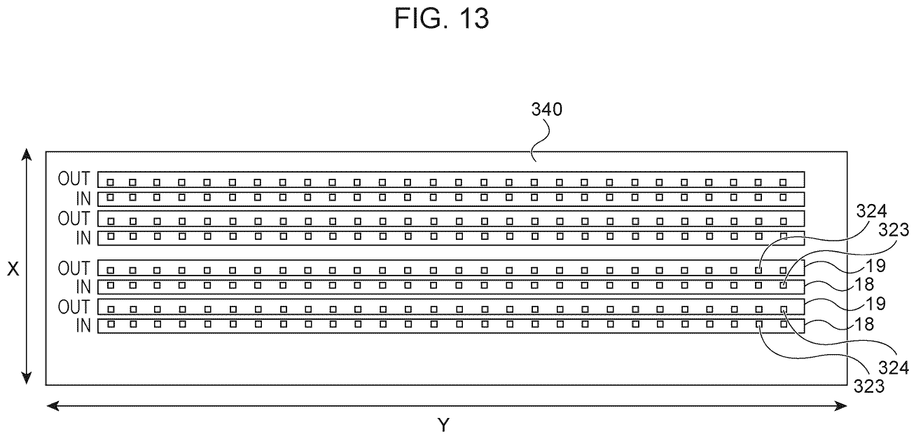

FIGS. 11A and 11B are schematic views illustrating a circulation path for one color liquid in a discharge unit 3 of the present embodiment. FIG. 11A is an exploded perspective view taken from the first support member 4 side of the discharge unit 3, and FIG. 11B is an exploded perspective view taken from the discharge module 300 side of the discharge unit 3. The arrows of IN and OUT in the drawings indicate liquid flows. The liquid flow will be described for one color only, but the flows of other colors are the same. In FIGS. 11A and 11B, the second support member 7 and the electric wiring member 5 are omitted, and the description thereof is omitted also in the following description of the configuration of the discharge unit. The first support member 4 in FIG. 11A is a cross section taken along the line XIA-XIA of FIG. 3A. The discharge module 300 includes a discharge element substrate 340 and an opening plate 330. FIG. 12 is a diagram illustrating the opening plate 330, and FIG. 13 is a diagram illustrating the discharge element substrate 340.

The discharge unit 3 is supplied with a liquid from the circulation unit 54 through a joint member 8 (see FIG. 3A). The path of a liquid from the joint member 8 until the joint member 8, where the liquid passes through and reaches, will now be described. In the following drawings, the joint member 8 is omitted.

The discharge module 300 includes a discharge element substrate 340 and an opening plate 330 composing a silicon substrate 310 and further includes a discharge port forming member 320. The discharge element substrate 340, the opening plate 330, and the discharge port forming member 320 overlap with each other and are bonded such that the flow channels of each liquid are communicated with each other to form the discharge module 300, and are supported by a first support member 4. The discharge module 300 is supported by the first support member 4 to form the discharge unit 3.

The discharge element substrate 340 includes a discharge port forming member 320, and the discharge port forming member 320 includes a plurality of discharge port rows each consisting of a plurality of discharge ports 13 and discharges part of the liquid, supplied through a liquid flow channel in the discharge module 300, from the discharge port 13. The liquid not discharged is collected from the liquid flow channel in the discharge module 300.

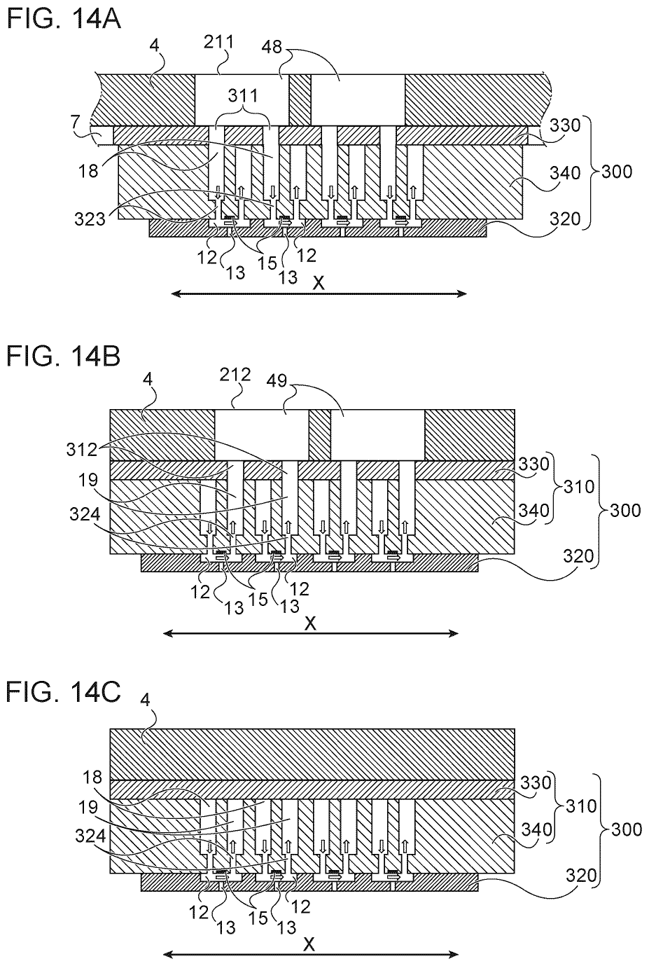

As shown in FIGS. 11A, 11B, and 12, the opening plate 330 includes a plurality of arranged liquid supply ports 311 and a plurality of arranged liquid collection ports 312. As shown in FIGS. 13 and 14A to 14C, the discharge element substrate 340 includes a plurality of arranged supply connection channels 323 and a plurality of arranged collection connection channels 324. The discharge element substrate 340 further includes a common supply channel 18 communicating with a plurality of the supply connection channels 323 and a common collection channel 19 communicating with a plurality of the collection connection channels 324. The flow channel in the discharge unit 3 is formed by communicating the liquid supply channel 48 and the liquid collection channel 49 (see FIG. 3A) provided in the first support member 4 and the flow channel provided in the discharge module 300. The support member supply port 211 is a cross-sectional opening forming the liquid supply channel 48, and the support member collection port 212 is a cross-sectional opening forming the liquid collection channel 49.

The liquid to be supplied to the discharge unit 3 is supplied to the liquid supply channel 48 (see FIG. 3A) of the first support member 4 from the circulation unit 54 (see FIG. 3A) side. The liquid passing through the support member supply port 211 in the liquid supply channel 48 is supplied to the common supply channel 18 of the discharge element substrate 340 through the liquid supply channel 48 (see FIG. 3A) and the liquid supply port 311 of the opening plate 330, and enters the supply connection channel 323. The channel up to this point is the supply side flow channel. Subsequently, the liquid passes through the pressure chamber 12 (see FIG. 3B) of the discharge port forming member 320 and flows to the collection connection channel 324 of the collection side flow channel. The detail of the liquid flow in the pressure chamber 12 will be described later.

In the collection side flow channel, the liquid entered into the collection connection channel 324 flows into the common collection channel 19. Subsequently, the liquid flows into the liquid collection channel 49 of the first support member 4 from the common collection channel 19 through the liquid collection port 312 of the opening plate 330, passes through the support member collection port 212, and is collected in the circulation unit 54.

The region in the opening plate 330 where there is no liquid supply port 311 and liquid collection port 312 corresponds to the region for separating the support member supply port 211 and the support member collection port 212 from each other in the first support member 4. The region does not include the first support member 4 and openings. Such a region is used as an adhesion region when the discharge module 300 and the first support member 4 are bonded to each other.

In FIG. 12, the opening plate 330 is provided with a plurality of rows each consisting of a plurality of openings arranged in the X direction and being arranged in the Y direction, wherein the openings are arranged such that supply (IN) openings and collection (OUT) openings are alternately arranged in the Y direction so as to be shifted by a half pitch in the X direction. In FIG. 13, in the discharge element substrate 340, common supply channels 18 communicating with a plurality of supply connection channels 323 arranged in the Y direction and common collection channels 19 communicating with a plurality of collection connection channels 324 arranged in the Y direction are alternately arranged in the X direction. The common supply channels 18 and the common collection channels 19 are separated by the type of the liquid, and the numbers of the common supply channel 18 and the common collection channel 19 to be arranged are determined depending on the number of the discharge port rows of each liquid type. The supply connection channels 323 and the collection connection channels 324 are also arranged in a number corresponding to the number of the discharge ports 13. It is not necessary to be a one-to-one correspondence, and one supply connection channel 323 and one collection connection channel 324 may correspond to a plurality of discharge ports 13.

The above-described opening plate 330 and the discharge element substrate 340 overlap with each other and are bonded such that the flow channels of each liquid are communicated with each other to form the discharge module 300 and are supported by a first support member 4 to form a liquid flow channel including the above-described supply channel and collection channel.

FIGS. 14A to 14C are cross-sectional views illustrating liquid flow in a discharge unit at different portions of the discharge unit 3. FIG. 14A is a cross section taken along the line XIVA-XIVA of FIG. 11A and shows a cross section of a portion where the liquid supply channel 48 and the liquid supply port 311 are communicated with each other in the discharge unit 3. FIG. 14B is a cross section taken along the line XIVB-XIVB of FIG. 11A and shows a cross section of a portion where the liquid collection channel 49 and the liquid collection port 312 are communicated with each other in the discharge unit 3. FIG. 14C is a cross section taken along the line XIVC-XIVC of FIG. 11A and shows a cross section of a portion where the liquid supply port 311 and the liquid collection port 312 are not communicated with the flow channel of the first support member 4.

In the supply channel for supplying a liquid, as shown in FIG. 14A, the liquid is supplied from a portion where the liquid supply channel 48 of the first support member 4 and the liquid supply port 311 of the opening plate 330 overlap and communicate with each other. In the collection channel for collecting a liquid, as shown in FIG. 14B, the liquid is collected from a portion where the liquid collection channel 49 of the first support member 4 and the liquid collection port 312 of the opening plate 330 overlap and communicate with each other. As shown in FIG. 14C, in part of the discharge unit 3, the opening plate 330 also includes a region not provided with an opening. In such a region, no liquid is supplied and collected between the discharge element substrate 340 and the first support member 4. As shown in FIG. 14A, a liquid is supplied in the region provided with the liquid supply port 311, and as shown in FIG. 14B, a liquid is collected in the region provided with the liquid collection port 312. In the present embodiment, although an example of a configuration using the opening plate 330 has been described, the configuration may be that not using the opening plate 330. In an example of the configuration, flow channels corresponding to the liquid supply channel 48 and the liquid collection channel 49 may be formed in the first support member 4, and the discharge element substrate 340 may be bonded to the first support member 4.

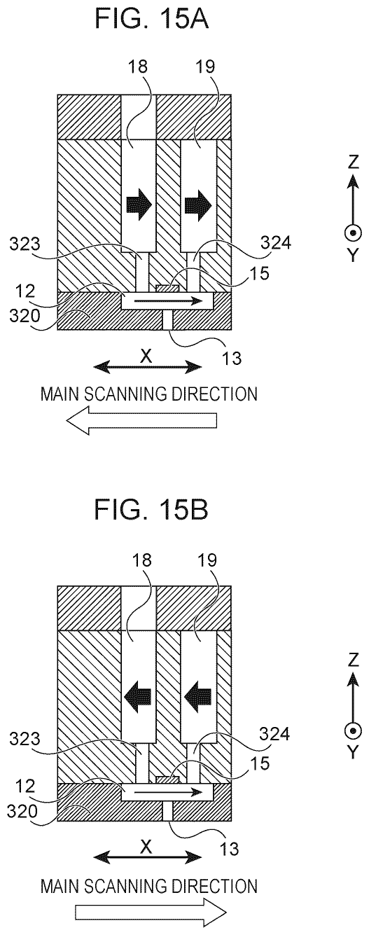

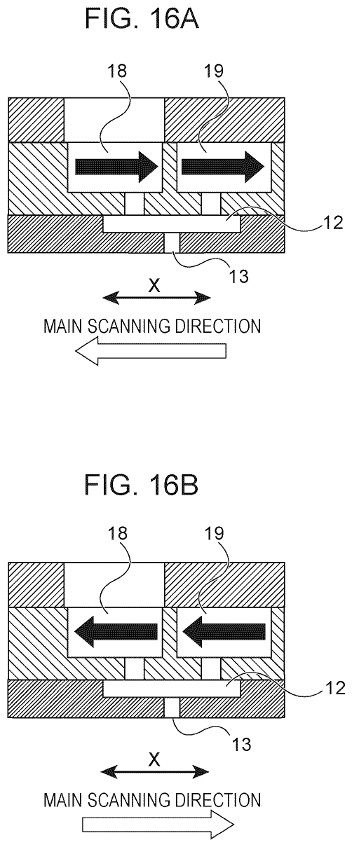

FIGS. 15A and 15B are cross-sectional views illustrating the vicinity of the discharge port 13 in the discharge module 300, and FIGS. 16A and 16B are cross-sectional views illustrating a discharge module having a configuration in which the common supply channel 18 and the common collection channel 19 are widened in the X direction as a comparative example. The thick arrows shown in the common supply channel 18 and the common collection channel 19 of FIGS. 15A, 15B, 16A, and 16B indicate fluctuations of a liquid in a configuration using a serial-type liquid discharge apparatus 50. The liquid passed through the common supply channel 18 and the supply connection channel 323 and supplied to the pressure chamber 12 is discharged from the discharge port 13 by driving the discharge element 15. When the discharge element 15 is not driven, the liquid is collected from the pressure chamber 12 to the common collection channel 19 through the collection connection channel 324 as a collection channel.

In a configuration using a serial-type liquid discharge apparatus 50, when the thus-circulating liquid is discharged, the discharge of the liquid is not a little influenced by the fluctuations of the liquid in the liquid flow channel by the main scanning of the liquid discharge head 1. Specifically, the influence by the fluctuations of the liquid in the liquid flow channel may appear as a difference in the discharge amount of the liquid and a deviation in the discharge direction. As shown in FIGS. 16A and 16B, when the common supply channel 18 and the common collection channel 19 have cross-sectional shapes wide in the X direction which is the main scanning direction, the liquid in the common supply channel 18 and the common collection channel 19 tends to receive inertial force in the main scanning direction, and large fluctuations occur in the liquid. As a result, the fluctuations of the liquid may affect the discharge of the liquid from the discharge port 13. If the common supply channel 18 and the common collection channel 19 are widened in the X direction, the distance between different types of liquids is widened, which may reduce the printing efficiency.

Accordingly, the common supply channel 18 and the common collection channel 19 of the present embodiment are configured so as to both extend in the Y direction in the cross sections shown in FIGS. 15A and 15B and also extend in the Z direction that is perpendicular to the X direction which is the main scanning direction. In such a configuration, the flow channel width of each of the common supply channel 18 and the common collection channel 19 in the main scanning direction can be decreased. The fluctuations of the liquid due to inertial force (thick black arrows in the drawings) acting on the liquid in the common supply channel 18 and the common collection channel 19 during scanning to the opposite side of the main scanning direction can be reduced by decreasing the flow channel width of each of the common supply channel 18 and the common collection channel 19 in the main scanning direction. Consequently, influence by the fluctuations of the liquid on discharge of the liquid can be suppressed. In addition, the cross-sectional area is increased by extending the common supply channel 18 and the common collection channel 19 in the Z direction, and flow channel pressure loss is thereby reduced.

As described above, it is configured such that the fluctuations of the liquid in the common supply channel 18 and the common collection channel 19 during main scanning are decreased by decreasing the flow channel width of each of the common supply channel 18 and the common collection channel 19 in the main scanning direction, but this does not mean that the fluctuations will disappear. Accordingly, in order to suppress the occurrence of a difference in discharge for each type of liquid, which may still occur by reduced fluctuations, in the present embodiment, it is configured such that the common supply channel 18 and the common collection channel 19 are arranged so as to overlap in the X direction.

As described above, in the present embodiment, the supply connection channel 323 and the collection connection channel 324 are provided corresponding to the discharge port 13, and the supply connection channel 323 and the collection connection channel 324 are arranged with the discharge port 13 therebetween in the X direction into a correspondence relation. Consequently, the common supply channel 18 and the common collection channel 19 have a portion not overlapping in the X direction, and if the correspondence relation between the supply connection channel 323 and the collection connection channel 324 in the X direction is broken, the flow and discharge of the liquid in the X direction in the pressure chamber 12 are influenced. The discharge of the liquid from each discharge port may be further influenced by the addition of the influence of fluctuations of the liquid.

Accordingly, the liquid fluctuations in the common supply channel 18 and the common collection channel 19 during main scanning are approximately the same at any position where the discharge ports 13 are arranged in the Y direction by arranging the common supply channel 18 and the common collection channel 19 so as to overlap in the X direction. As a result, the pressure difference between the common supply channel 18 side and the common collection channel 19 side occurring in the pressure chamber 12 does not significantly vary, and stable discharge can be performed.

Some liquid discharge heads for circulating liquids are configured such that the flow channel for supplying a liquid to the liquid discharge head and the flow channel for collecting the liquid are the same. However, in the present embodiment, the common supply channel 18 and the common collection channel 19 are different flow channels. The supply connection channel 323 and the pressure chamber 12 communicate with each other, the pressure chamber 12 and the collection connection channel 324 communicate with each other, and the liquid is discharged from the discharge port 13 of the pressure chamber 12. That is, it is configured that the pressure chamber 12 that is a path for connecting between the supply connection channel 323 and the collection connection channel 324 includes the discharge port 13. Accordingly, in the pressure chamber 12, a flow of the liquid flowing from the supply connection channel 323 side to the collection connection channel 324 side is generated, and the liquid in the pressure chamber 12 is efficiently circulated. It is possible to keep the liquid in the pressure chamber 12, which tends to be influenced by evaporation of the liquid through the discharge port 13, in a fresh state by efficiently circulating the liquid in the pressure chamber 12.

If discharge at a high flow rate is necessary by communicating two flow channels, the common supply channel 18 and the common collection channel 19, with the pressure chamber 12, it is also possible to supply the liquid from both flow channels. That is, the configuration in the present embodiment has a merit of being able to efficiently circulate a liquid and also to correspond to high flow rate discharge compared to a configuration in which the supply and collection of a liquid is performed with one flow channel only.

In addition, the influence by fluctuations of the liquid is less likely to occur when the common supply channel 18 and the common collection channel 19 are arranged closer to each other in the X direction. Desirably, the distance between the flow channels is 75 to 100 μm.

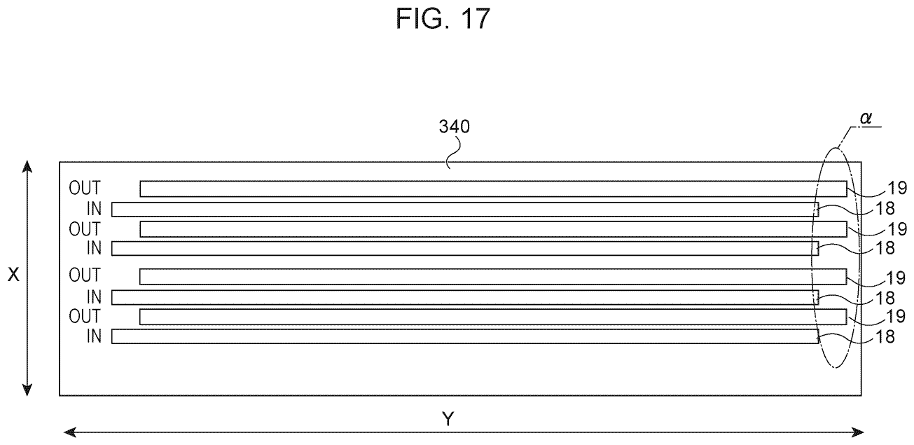

FIG. 17 is a diagram illustrating a discharge element substrate 340 as a comparative example. In FIG. 17, the illustration of the supply connection channel 323 and the collection connection channel 324 is omitted. Since the liquid received thermal energy by the discharge element 15 in the pressure chamber 12 flows into the common collection channel 19, the liquid with a temperature relatively high with respect to the temperature of the liquid in the common supply channel 18 flows. On this occasion, in the comparative example, as the a portion surrounded by the dashed line in FIG. 17, in a portion of the discharge element substrate 340 in the X direction, there is a portion where only the common collection channel 19 exists. In this case, the temperature is locally increased at the portion to cause temperature unevenness in the discharge module 300, which may affect the discharge.

In the common supply channel 18, a liquid with a temperature relatively low with respect to that in the common collection channel 19 flows. Accordingly, when the common supply channel 18 and the common collection channel 19 are adjacent to each other, in the vicinity thereof, the temperatures in the common supply channel 18 and the common collection channel 19 set-off with each other to suppress an increase in the temperature. Accordingly, the common supply channel 18 and the common collection channel 19 may have approximately the same length, be present at positions overlapping in the X direction, and be adjacent to each other.

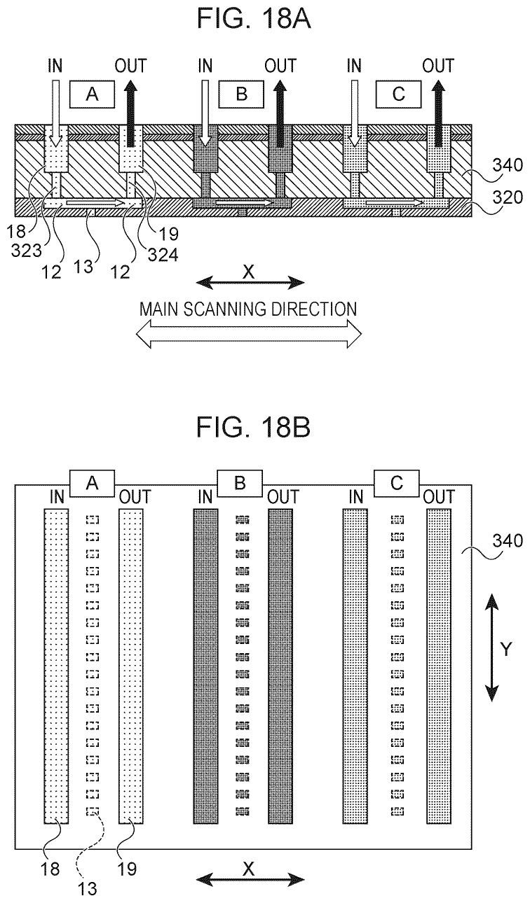

FIGS. 18A and 18B are diagrams illustrating a flow channel configuration of a liquid discharge head 1 corresponding to 3 types of discharge liquids. As shown in FIG. 18A, the liquid discharge head 1 has circulation flow channels for the respective types of the inks (liquids). The pressure chamber 12 is provided along the X direction which is the main scanning direction of the liquid discharge head 1. As shown in FIG. 18B, the common supply channel 18 and the common collection channel 19 are provided along the discharge port rows in which the discharge ports 13 are arrayed so as to extend in the Y direction and sandwich the discharge port row therebetween.

### Connection of Main Body Portion and Liquid Discharge Head

FIG. 19 is a schematic configuration diagram illustrating in more detail the connection status of the ink tank 2 and external pump 21 with the liquid discharge head 1 provided in the main body portion of the liquid discharge apparatus 50 of the present embodiment, and the arrangement of the circulation pump and so on. The liquid discharge apparatus 50 in the present embodiment has a configuration in which only the liquid discharge head 1 can be easily replaced when malfunction occurs in the liquid discharge head 1. Specifically, the liquid discharge apparatus 50 includes a liquid connection part 700 that can easily perform connection and disconnection between the supply tube 59 and liquid discharge head 1 connected to the external pump 21. Consequently, only the liquid discharge head 1 can be easily attached and detached from the liquid discharge apparatus 50.

As shown in FIG. 19, the liquid connection part 700 includes a liquid connector insertion port 53a provided to the head housing 53 of the liquid discharge head 1 in a protruding state and a cylindrical liquid connector 59a that can be inserted into the liquid connector insertion port 53a. The liquid connector insertion port 53a is fluidically connected to the liquid supply channel (inlet flow channel) formed in the liquid discharge head 1 and is connected to the first pressure regulation unit 120 through the above-described filter 110. The liquid connector 59a is provided to the tip of the supply tube 59 connected to the external pump 21 that pressurization-supplies the liquid in the ink tank 2 to the liquid discharge head 1.

The liquid discharge head 1 shown in FIG. 19 as in above can be easily attached, detached, and replaced by the liquid connection part 700. However, when the sealing property between the liquid connector insertion port 53a and the liquid connector 59a is reduced, the liquid pressurization-supplied by the external pump 21 may leak from the liquid connection part 700. If the leaked liquid adheres to the circulation pump 500 or the like, there is a risk of causing malfunction in the electric system. Accordingly, in the present embodiment, the circulation pump and so on are arranged as follows.

### Arrangement of Circulation Pump and so on

As shown in FIG. 19, in the present embodiment, in order to avoid the liquid leaked from the liquid connection part 700 from adhering to the circulation pump 500, the circulation pump 500 is arranged above the liquid connection part 700 in the gravity direction. That is, the circulation pump 500 is arranged above the liquid connector insertion port 53a, which is an inlet port for a liquid in the liquid discharge head 1, in the gravity direction. Furthermore, the circulation pump 500 is arranged at a position where it is in non-contact with members constituting the liquid connection part 700.

Consequently, even if a liquid leaks from the liquid connection part 700, since the liquid flows in the horizontal direction, which is the opening direction of the liquid connector 59a, or downward in the gravity direction, it is possible to prevent the liquid from reaching the circulation pump 500 located upward in the gravity direction. In addition, since the circulation pump 500 is located at a position away from the liquid connection part 700, a risk that a liquid travels through the members and reaches the circulation pump 500 is also reduced.

The electrical connection portion 515 for electrically connecting between the circulation pump 500 and the electric contact substrate 6 via a flexible wiring member 514 is provided above the liquid connection part 700 in the gravity direction. Consequently, a risk of causing an electrical trouble by a liquid from the liquid connection part 700 can be reduced.

In the present embodiment, since the wall 53b of the head housing 53 is provided, even if a liquid spouts from the opening 59b of the liquid connection part 700, it is possible to block the liquid and reduce a risk that the liquid reaches the circulation pump 500 or the electrical connection portion 515.

The circulation system of a liquid may be configured such that an ink circulates in an area including from downstream of the external pump (first external pump) 21 to the carriage 60. In such a case, it is possible to stir the ink also in the flow channel other than the liquid discharge head 1 of the liquid discharge apparatus 50. In particular, when applied to a circulation system for a white ink containing titanium oxide, it is possible to suppress an excessive increase in the manufacturing cost of the apparatus and an increase in the size of the apparatus while obtaining a greater effect of suppressing precipitation of the ink containing titanium oxide.

### Temperature Control Unit

In the printing method of the present disclosure, the liquid discharge head is configured so as to discharge an aqueous ink and an aqueous reaction liquid containing a reactant that reacts with the aqueous ink. Here, the discharge balance between the aqueous reaction liquid and the aqueous ink is disrupted due to a difference in the viscosities of the aqueous ink and the aqueous reaction liquid, and image unevenness may occur. In general, many of aqueous inks containing a colorant particle, a resin, and the like have a viscosity lower than that of an aqueous reaction liquid. Accordingly, as described above, in the printing method of the present disclosure, at least one of the ink or the reaction liquid is heated with a temperature control unit to adjust the viscosity of a discharge liquid. Consequently, the discharge balance between the aqueous reaction liquid and the aqueous ink is tuned to give an effect of suppressing image unevenness. Examples of the temperature control unit include a heater for regulating discharge liquid temperature arranged so as to be in contact with the liquid discharge head and a heater for liquid discharge (electrothermal conversion element). Heating of a discharge liquid by a heater for ink discharge may be performed by, for example, repeatedly applying a current that does not cause discharge of a liquid. The viscosity of a liquid is decreased by heating the liquid in the liquid discharge head. The discharge balance between the aqueous reaction liquid and the aqueous ink is tuned by adjusting the temperature so as to decrease the viscosity difference between the ink and the reaction liquid, and an effect of suppressing image unevenness is obtained.

A decrease of the viscosity of the discharge liquid by heating makes it easy to supply (refill) the liquid, and an effect of enabling stable continuous discharge and liquid circulation is also obtained.

In the ink jet printing method of the present disclosure, in particular, an ink that tends to have a viscosity higher than that of a reaction liquid may be heated to a temperature higher than the printing environmental temperature (for example, about 25° C.) by the above-described temperature control unit in the liquid discharge head and then discharged. Specifically, an ink is preferably heated to 30° C. or more and 80° C. or less and further preferably 35° C. or more and 70° C. or less. That is, the temperature of an ink when discharged, i.e., the temperature T1 (° C.) of an ink after heating may be 30° C. or more and 80° C. or less or may be 35° C. or more and 70° C. or less.

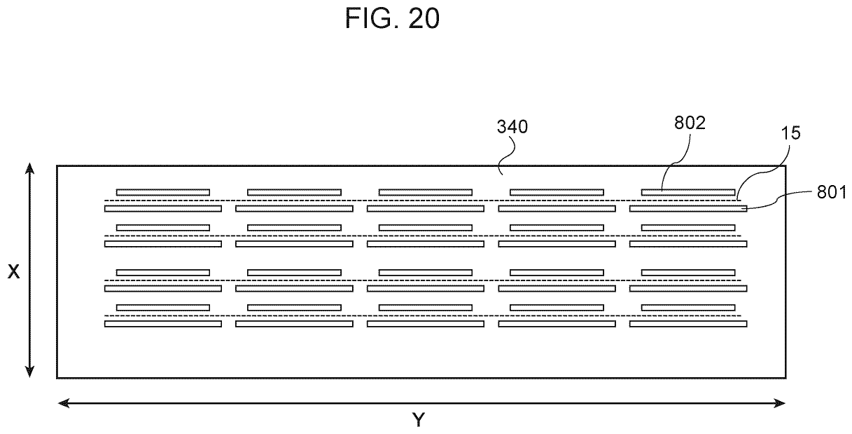

In the present embodiment, the discharge element substrate 340 includes a heater for heating a liquid in the vicinity of the discharge element. In an example of the configuration, the discharge element substrate 340 is sectioned into multiple regions, and a temperature control heater and a temperature sensor are provided in each section. FIG. 20 is a diagram illustrating a discharge element substrate 340 and is the rear side face of the substrate shown in FIG. 13. In FIG. 20, a temperature control heater 801 as the temperature control unit and a temperature sensor 802 are disposed in the vicinity of the discharge element 15 in each section in the discharge element substrate 340. In this case, a CPU 103 (see FIG. 1B) controls the temperature using these temperature control heater 801 and temperature sensor 802 based on the temperature set for each region. That is, the CPU 103 drives the temperature control heater 801 in only the region where the detection temperature of the temperature sensor 802 is the target temperature or less. The temperature variation in a printing element substrate 10 and the temperature variation between multiple discharge element substrates 340 are kept within certain ranges by performing such temperature control to reduce the variation in the discharge amount due to the temperature variation, and it is possible to suppress concentration unevenness in a printed image. As the temperature sensor, a diode sensor, an aluminum sensor, and so on can be used.

Furthermore, as described above in the printing method of the present disclosure, the circulation path of the discharge liquid is configured so as to be completed in the liquid discharge head. Consequently, the total volume of the circulation path can be reduced compared to a configuration in which the circulation of a discharge liquid is performed between the liquid discharge head and the outside thereof. As a result, it is possible to shorten the time necessary for stabilizing the liquid temperature in the circulation path and to improve the productivity. In addition, since the liquid in the circulation path is hardly cooled, the drive frequency of the temperature control heater can be decreased, and it is also possible to reduce the power consumption necessary for maintaining the temperature of the liquid.

The total volume of an ink flowing in one circulation path is preferably 30 mL or less and more preferably 15 mL or less and is preferably 5 mL or more. That is, the volume of a liquid flowing in the circulation path is preferably 5 mL or more and 30 mL or less and further preferably 5 mL or more and 15 mL or less.

When the discharge element substrate 340 includes a temperature control unit configured so as to be capable of heating an ink and a temperature control unit configured so as to be capable of heating a reaction liquid, the temperature control unit provided in the discharge element substrate 340 may be arranged for each of discharge port rows corresponding to different types of the discharge liquids. A plurality of temperature control units such as temperature control heaters may be arranged in one discharge port row.

Discharge port rows that discharge inks may be configured so as to discharge multiple types of inks (for example, three colors of cyan, magenta, and yellow) from one row. The temperatures of an ink and a reaction liquid are respectively controlled by providing a discharge port row (first discharge port row) corresponding to the ink and a discharge port row (second discharge port row) corresponding to the reaction liquid, and the discharge balance is more likely to be tuned.

The discharge module 300 for discharging an ink and a discharge module 300 for discharging a reaction liquid may be separated from each other. That is, the liquid discharge head 1 may include multiple discharge modules 300 including a discharge module 300 (first element substrate) for discharging the ink and a discharge module 300 (second element substrate) for discharging the reaction liquid. In such a case, the temperatures of the ink and the reaction liquid can be respectively more efficiently controlled.

When the viscosity of the ink at a printing environmental temperature (e.g., about 25° C.) is higher than the viscosity of the reaction liquid, the adjusted temperature t₁ of the ink adjusted by a temperature control unit is set to be higher than the adjusted temperature t₂ of the reaction liquid. In contrast, when the viscosity of the ink at a printing environmental temperature is lower than the viscosity of the reaction liquid, the adjusted temperature t₁ of the ink is set to be lower than the adjusted temperature t₂ of the reaction liquid.

The temperature control unit may be disposed in the discharge unit 3 other than the discharge element substrate 340 or may be disposed in a circulation unit (in the circulation unit 54). In either case, the temperature control unit may be arranged on the upstream side in the circulation path of a liquid, i.e., in the path in which the liquid flows into the pressure chamber 12 from the circulation pump 500. When the temperature control unit is arranged in the discharge unit 3, the temperature control unit may be arranged at each of a supply port 88, a liquid supply channel 48, a common supply channel 18, and a supply connection channel 323.

The temperature control unit may be configured such that a discharge liquid can be heated in an ink tank 2 or a supply tube 59 outside the liquid discharge head 1. In such a case, temperature control units may be provided for each of the ink and the reaction liquid.

A configuration including a cooling mechanism for cooling the discharge liquid may also be considered as the temperature control unit. An ink often has a viscosity higher than that of a reaction liquid at the printing environmental temperature, but the temperature of the reaction liquid is increased by the energy and so on during discharging, and the viscosity of the reaction liquid may become too low compared to that of the ink. In such a case, it is possible to control the viscosity of the reaction liquid by decreasing the temperature of the reaction liquid with a cooling mechanism such as a Peltier device and a fan and to tune the discharge balance between the reaction liquid and the ink.

### (2) Reaction Liquid

Each component and so on that is used in the aqueous reaction liquid of the present disclosure will now be described in detail.

### Reactant

The reaction liquid is brought into contact with an ink and thereby reacts with the ink to aggregate the components (resin and a component having an anionic group such as a self-dispersible pigment) in the ink, and contains a reactant. Examples of the reactant include a polyvalent metal salt, an organic acid, and a cationic resin. Any reactant can be added to the reaction liquid within a range that gives desired characteristics, such as storage stability of the reaction liquid, intermittent discharge stability, and image unevenness suppression.

In the reaction liquid containing a polyvalent metal salt, the polyvalent metal salt, which is a compound composed of a divalent or higher valent metal ion and an anion, is dissociated in the reaction liquid and becomes a multivalent metal ion, which can aggregate a colorant that is dispersed by the action of the anionic group contained in the ink.

Examples of the multivalent metal ion include divalent metal ions such as Ca²⁺, Cu²⁺, Ni²⁺, Mg²⁺, Sr²⁺, Ba²⁺, and Zn²⁺; and trivalent metal ions such as Fe³⁺, Cr³⁺, Y³⁺, and Al³⁺. In order to obtain a reaction liquid containing a multivalent metal ion, a polyvalent metal salt (which may be a hydrate) composed of a multivalent metal ion and an anion can be used. Examples of the anion include inorganic anions such as Cl⁻, Br, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻, and H₂PO₄⁻; and organic anions such as HCOO⁻, (COO⁻)₂, COOH(COO⁻), CH₃COO⁻, C₂H₅COO⁻, CH₃CH(OH)COO⁻, C₂H₄ (COO⁻)₂, C₆H₅COO⁻, C₆H₄ (COO⁻)₂, and CH₃SO₃⁻. The content (mass %) of the polyvalent metal salt in the reaction liquid may be 1.0 mass % or more and 20.0 mass % or less based on the total mass of the reaction liquid.

The solubility (g/100 mL) of the polyvalent metal salt in water at 25° C. may be 25.0 g/100 mL or more. When the solubility is less than 25.0 g/100 mL, the dissolved state of the polyvalent metal salt in the reaction liquid tends to be unstable, and the polyvalent metal salt tends to precipitate. Since the precipitated polyvalent metal salt may reduce its reactivity with the ink, the image unevenness may not be sufficiently suppressed. The solubility may be 50.0 g/100 mL or less.

The reaction liquid containing an organic acid has buffer ability in an acidic region (less than pH 7.0, preferably pH 2.0 to 5.0) and thereby efficiently converts the anionic group of a component present in the ink into an acid form to aggregate it. Examples of the organic acid include monocarboxylic acids, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid, and coumaric acid, and salts thereof; dicarboxylic acids, such as oxalic acid, maleic acid, succinic acid, glutaric acid, adipic acid, maleic acid, fumaric acid, itaconic acid, sebacic acid, phthalic acid, malic acid, and tartaric acid, and salts and hydrogen salts thereof; tricarboxylic acids, such as citric acid and trimellitic acid, and salts and hydrogen salts thereof; and tetracarboxylic acids, such as pyromellitic acid, and salts and hydrogen salts thereof. When containing an organic acid, the content (mass %) of the organic acid in the reaction liquid may be 1.0 mass % or more and 50.0 mass % or less based on the total mass of the reaction liquid.

Examples of the cationic resin include resins with primary to tertiary amine structures and a resin with a quaternary ammonium salt structure, specifically, resins with structures such as vinylamine, allylamine, vinylimidazole, vinylpyridine, dimethylaminoethyl methacrylate, ethyleneimine, guanidine, diallyldimethylammonium chloride, and alkylamine-epichlorohydrin condensate. In order to increase the solubility in the reaction liquid, a combination of a cationic resin and an acidic compound may be used, or a cationic resin may be quaternized. When containing a cationic resin, the content (mass %) of the cationic resin in the reaction liquid may be 0.1 mass % or more and 10.0 mass % or less based on the total mass of the reaction liquid.

### Other Components

The reaction liquid may contain various other components as needed. Examples of such components include the same components that can be added to an ink as additional components described later.

### Physical Property of Reaction Liquid

The reaction liquid that can be suitably used in the printing method of the present disclosure is an aqueous reaction liquid that is applied to an ink jet system. Accordingly, from the viewpoint of reliability, the physical property values can be suitably controlled. Specifically, the surface tension of the reaction liquid at 25° C. may be 20 mN/m or more and 60 mN/m or less. The viscosity of the reaction liquid at 25° C. may be 1.0 mPa·s or more and 10.0 mPa·s or less. The pH of the reaction liquid at 25° C. may be 5.0 or more and 9.5 or less or 6.0 or more and 9.0 or less.

### (3) Ink

The ink that can be used in the ink jet printing method of the present disclosure will now be described in detail by citing embodiments. In the present disclosure, when a compound is a salt, the salt in an ink is present as a dissociated ion, but is expressed as “containing a salt” for convenience. Titanium oxide and a titanium oxide particle may be simply referred to as “pigment”. An aqueous ink for ink jet printing may be simply referred to as “ink”. A physical value is a value at normal temperature (25° C.) unless otherwise noted. When an image of a white ink described later is printed, the white ink may be used in background color treatment for color inks. In such a case, an image may be printed by applying color inks (such as black, cyan, magenta, and yellow inks) so as to overlap with at least part of the region to which a white ink was applied. Alternatively, the ink can also be used in back printing in which a white ink is applied so as to overlap at least part of the region to which color inks were applied.

The ink of the present disclosure is an aqueous ink for ink jet printing and contains a colorant that is dispersed by the action of an anionic group. The ink of the present disclosure does not need to be a so-called “curing ink”. Accordingly, the ink of the present disclosure does not need to contain a compound, such as a polymerizable monomer, that can polymerize by application of external energy such as heat and light. The components constituting the ink of the present disclosure, the physical properties of the ink, and so on will now be described in detail.

### Colorant

The ink contains a colorant that is dispersed by anionic action. As the colorant, a pigment and a dye can be used. The content (mass %) of the colorant in the ink is preferably 0.1 mass % or more and 15.0 mass % or less and further preferably 1.0 mass % or more and 10.0 mass % or less based on the total mass of the ink.

Specifically, examples of the pigment include inorganic pigments such as carbon black and titanium oxide; and organic pigments such as azo, phthalocyanine, quinacridone, isoindolinone, imidazolone, diketopyrrolopyrrole, and dioxazine.

As the dispersion system of a pigment, a resin-dispersed pigment using a resin as the dispersant, a self-dispersible pigment in which a hydrophilic group is bonded to the particle surface of the pigment, or the like can be used. A resin-bound pigment in which an organic group including a resin is chemically bonded to the particle surface of the pigment and a microcapsule pigment in which the surface of the pigment particle is coated with a resin or the like can also be used. In particular, a resin-dispersed pigment in which a resin as a dispersant is physically adsorbed to the particle surface of the resin may be used rather than the resin-bound pigment and the microcapsule pigment. That is, the pigment may be dispersed by a resin (resin dispersant) having an anionic group.

As the resin dispersant for dispersing a pigment in an aqueous medium, a resin dispersant that can disperse a pigment in an aqueous medium by the action of an anionic group is used. As the resin dispersant, a resin described later, in particular, a water-soluble resin can be used. The content (mass %) of the pigment in the ink may be 0.3 times or more and 10.0 times or less as a mass ratio to the content of the resin dispersant.

As the self-dispersible pigment, a pigment in which an anionic group such as a carbonic acid group, a sulfonic acid group, or a phosphonic acid group is directly or via another atomic group (—R—) bonded to the particle surface of the pigment can be used. The anionic group may be in either acid form or salt form, and the salt form may be either partially or completely dissociated. When the anionic group is in a salt form, examples of the cation that becomes the counter ion include an alkali metal cation, ammonium, and organic ammonium. Examples of the atomic group (—R—) include a linear or branched alkylene group having 1 to 12 carbon atoms; an arylene group such as a phenylene group and a naphthylene group; a carbonyl group; an imino group; an amide group; a sulfonyl group; an ester group; and an ether group. A combination of these groups may be used.

As the dye, a dye having an anionic group is used. Examples of the dye include azo, triphenylmethane, (aza) phthalocyanine, xanthene, and anthrapyridone. The colorant may be a pigment, in particular, a resin-dispersed pigment.

### Colorant (White Ink)

The present disclosure can be suitably used in an ink jet printing method using an ink containing titanium oxide as a colorant. Since titanium oxide is a white pigment, this ink may be a white ink. In an ink jet printing method utilizing a reaction liquid containing a reactant that reacts with an ink as in the present disclosure, as described above, a non-absorbable print medium formed of vinyl chloride (VC), polyethylene terephthalate (PET), or the like is often used. In such a case, printing using a white ink containing titanium oxide can print an image with high color development regardless of the color of the print medium itself. The colorant in a white ink containing titanium oxide will now be described.

The white ink contains titanium oxide as a colorant (pigment). Titanium oxide may be a titanium oxide particle surface-treated with a specific inorganic oxide. That is, the white ink may contain a titanium oxide particle that is titanium oxide of which the surface is coated with a specific inorganic oxide.

The content (mass %) of the titanium oxide particle in an ink may be 0.10 mass % or more and 20.00 mass % or less based on the total mass of the ink. Alternatively, the content (mass %) of the titanium oxide particle in an ink may be 1.00 mass % or more and 20.00 mass % or less based on the total mass of the ink. In particular, the content (mass %) of the titanium oxide particle in an ink may be 1.00 mass % or more and 15.00 mass % or less based on the total mass of the ink.

Titanium oxide is a white pigment and has three crystal forms: rutile, anatase, and brookite. In particular, the titanium oxide may be rutile titanium oxide. Examples of an industrial manufacturing method of titanium oxide include a sulfuric acid method and a chlorine method, and the titanium oxide used in the present disclosure may be manufactured by any manufacturing method.

The volume-based cumulative 50% particle size (hereinafter, also referred to as average particle size) of the titanium oxide particle may be 200 nm or more and 500 nm or less. In particular, the volume-based cumulative 50% particle size of the titanium oxide particle may be 200 nm or more and 400 nm or less.

The volume-based cumulative 50% particle size (D50) of a titanium oxide particle is the diameter of a particle that is 50% in a particle size cumulative curve when cumulated from the small particle size side based on the total volume of the measured particles. The D50 of a titanium oxide particle can be measured under conditions, for example, SetZero: 30 seconds, number of measurements: 3 times, measurement time: 180 seconds, shape: nonspherical, and refractive index: 2.60. As the particle size distribution measurement apparatus, a particle size analyzer using a dynamic light scattering method can be used. The measurement conditions and so on are not limited to the above.

Titanium oxide surface-treated with alumina and silica may be used. The surface treatment is expected to suppress photocatalytic activity and improve dispersibility. In the present specification, “alumina” is a generic name of oxides of aluminum such as aluminum oxide. In the present specification, “silica” is a generic name of silicon dioxide and a material constituted of silicon dioxide. Alumina and silica coating titanium oxide are mostly present in forms of silicon dioxide and aluminum oxide, respectively.

The proportion (mass %) of titanium oxide in the titanium oxide particle may be 90.00 mass % or more based on the total mass of the titanium oxide particle. The proportion (mass %) of titanium oxide in the titanium oxide particle may be 98.50 mass % or less based on the total mass of the titanium oxide particle. The mass ratio of the proportion (mass %) of alumina to the proportion (mass %) of silica in the titanium oxide particle is required to be 0.50 times or more and 1.00 times or less. When the mass ratio is less than 0.50 times or greater than 1.00 times, discharge stability of the ink cannot be obtained. The proportion (mass %) of silica in the titanium oxide particle may be 1.00 mass % or more and 4.00 mass % or less based on the total mass of the titanium oxide particle. When the proportion (mass %) of silica is less than 1.00 mass %, the affinity with a compound represented by formula (1) is not sufficiently obtained, and the discharge stability of the ink may become insufficient. When the proportion (mass %) of silica is greater than 4.00 mass %, even if surface treatment with alumina is performed, the amount of the compound represented by the formula (1) adsorbed to the titanium oxide particle cannot be suppressed, and the discharge stability of the ink may become insufficient. The proportion (mass %) of alumina in the titanium oxide particle may be 0.50 mass % or more and 4.00 mass % or less based on the total mass of the titanium oxide particle.

Examples of the method for measuring the proportion of alumina and silica in the titanium oxide particle, i.e., the coating amount of alumina and silica include quantitative analysis of aluminum and silicon elements by inductive coupling plasma (ICP) optical emission spectrometry. In such a case, the proportion can be calculated by assuming that all atoms coating the surface are oxides and converting the obtained amounts of aluminum and silicon into the oxides thereof, i.e., alumina and silica. The mass ratio of the proportion (mass %) of aluminum elements to the proportion (mass %) of silicon elements obtained by inductive coupling plasma optical emission spectrometry in the titanium oxide particle is 0.57 times or more and 1.13 times or less. When this value is converted into the oxides thereof, i.e., alumina and silica, the mass ratio of the proportion (mass %) of alumina to the proportion (mass %) of silica in the titanium oxide particle is 0.50 times or more and 1.00 times or less.

Examples of the method for surface treatment of titanium oxide include wet treatment and dry treatment. For example, surface treatment can be performed by dispersing titanium oxide in a liquid medium and then reacting it with a surface treating agent such as sodium aluminate and sodium silicate. Desired characteristics can also be adjusted by appropriately changing the ratio of these surface treating agents. The surface treatment can also use an inorganic oxide such as zinc oxide and zirconia or an organic material such as polyol, in addition to alumina and silica, as long as the effects of the present disclosure are not impaired.

As long as the effects of the present disclosure are not impaired, the white ink may contain a pigment other than titanium oxide. In such a case, the ink may be any color ink other than a white ink. The content (mass %) of the pigment other than titanium oxide in the ink is preferably 0.10 mass % or more and 5.00 mass % or less and more preferably 0.10 mass % or more and 1.00 mass % or less based on the total mass of the ink. Compound represented by formula (1)

The ink may contain a compound represented by the formula (1) below as a dispersant for dispersing the titanium oxide particle. The content (mass %) of the compound represented by the formula (1) in the ink is preferably 0.01 mass % or more and 1.00 mass % or less based on the total mass of the ink and further preferably 0.02 mass % or more and 0.50 mass % or less.

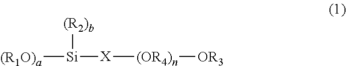

(in the formula (1), R₁, R₂, and R₃ are each independently a hydrogen atom or an alkyl group having 1 to 4 carbon atoms; R₄'s are each independently an alkylene group having 2 to 4 carbon atoms; X is a single bond or an alkylene group having 1 to 6 carbon atoms; n is from 6 to 24; and
a is from 1 to 3, b is from 0 to 2, and a +b=3).

In the formula (1), R₁, R₂, and R₃ are each independently a hydrogen atom or an alkyl group having 1 to 4 carbon atoms. Examples of the alkyl group having 1 to 4 carbon atoms include a methyl group, an ethyl group, an n-propyl group, an i-propyl group, and an n-butyl group. In particular, from the viewpoint of ease of hydrolysis, the alkyl group may be a methyl group. When R₁, R₂, and R₃ are each an alkyl group having more than 4 carbon atoms, it becomes difficult to form a silanol group by hydrolysis, and affinity to the titanium oxide particle is not obtained. Accordingly, the titanium oxide particle cannot be stably dispersed, and the discharge stability of the ink is not obtained. “a” representing the number of RIO is from 1 to 3, “b” representing the number of R₂ is from 0 to 2, and a +b=3. In particular, “a” may represent 3 and “b” may represent 0, that is, all three substituents of the silicon atom may be RIO.

In the formula (1), R₄'s are each independently an alkylene group having 2 to 4 carbon atoms. Examples of the alkylene group having 2 to 4 include an ethylene group, an n-propylene group, an i-propylene group, and an n-butylene group. In particular, the alkylene group may be an ethylene group. The number of OR₄, that is, n representing the number (average) of alkylene oxide groups is from 6 to 24. When n is less than 6, since the length of the alkylene oxide chain is too short, the repulsive force by steric hindrance is not sufficiently obtained, and the discharge stability of the ink is not obtained. When n is greater than 24, since the length of the alkylene oxide chain is too long, the affinity is increased, which makes it easier to release into the aqueous medium. Accordingly, affinity with the surface hydroxy group of the titanium oxide particle is not sufficiently obtained, and aggregation of the titanium oxide particle cannot be suppressed. Accordingly, the titanium oxide particle cannot be stably dispersed, and the discharge stability of the ink is not obtained.

In the formula (1), X is a single bond or an alkylene group having 1 to 6 carbon atoms. When X is a single bond, it is meant that a silicon atom and OR₄ are directly bonded to each other. Examples of the alkylene group having 1 to 6 carbon atoms include a methylene group, an ethylene group, an n-propylene group, an i-propylene group, an n-butylene group, an n-pentylene group, and an n-hexylene group. In particular, the alkylene group may be an n-propylene group. When the X is an alkylene group having greater than 6 carbon atoms, the hydrophobicity of the compound represented by the formula (1) becomes too high, the titanium oxide particle cannot be stably dispersed, and the discharge stability of the ink cannot be obtained.

The compound represented by the formula (1) as a dispersant for the titanium oxide particle may be a compound represented by the following formula (2). In the compound represented by the formula (2), since the number of OR₁ binding to a silicon atom is three, a part thereof is hydrolyzed in an aqueous medium, and three hydroxy groups binding to the silicon atom can be formed to increase a site having affinity with the titanium oxide particle. The compound represented by the following formula (2) has a repeating structure of an ethylene oxide group. Consequently, the ethylene oxide chain appropriately extends in an aqueous medium, and it is possible to obtain repulsive force due to steric hindrance.

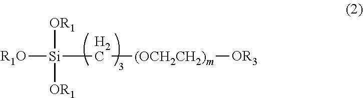

(in the formula (2), R₁ and R₃ are each independently a hydrogen atom or an alkyl group having 1 to 4 carbon atoms; and m is from 8 to 24).

The mass ratio of the content (mass %) of the compound represented by the formula (1) to the content (mass %) of the titanium oxide particle in the ink may be 0.002 times or more and 0.10 times or less. When the mass ratio is less than 0.002 times, the function of stably dispersing the titanium oxide particle is weakened, and the discharge stability of the ink may become insufficient. When the mass ratio is greater than 0.10 times, the proportion of the compound represented by the formula (1) is too high, condensation (self-condensation) between molecules of the compound represented by the formula (1) tends to occur. Consequently, the compound represented by the formula (1) is consumed without functioning as a dispersant, the function of stably dispersing the titanium oxide particle is weak, and the discharge stability of the ink may become insufficient.

The compound represented by the formula (1) forms a hydrogen bond with the surface hydroxy group of the titanium oxide particle, and it is inferred that a part thereof forms a covalent bond by dehydration reaction. However, in the present disclosure, the compound represented by the formula (1) can disperse the titanium oxide particle even if a covalent bond with the titanium oxide particle is not formed. That is, the amount of the compound represented by the formula (1) forming a covalent bond with the titanium oxide particle is very small and can be ignored. Consequently, the compound represented by the formula (1) covalent-bonded to the titanium oxide particle is not included in the content of the titanium oxide particle. As a result of study by the present inventors, it was found that if the amount of the compound represented by the formula (1) covalent-bonded to the titanium oxide particle is too large, the discharge stability of the ink decreases.

The reason of the above is inferred as follows. Since electrostatic attraction becomes less effective generally in a liquid medium with high dielectric constant such as water, the titanium oxide particle freely moves without being significantly influenced by the surrounding environment. However, if the compound represented by the formula (1) is covalent-bonded to titanium oxide particle, the portion (portion of OR₄) having hydrophilicity of the structure of the formula (1) forms a hydrogen bond with a water molecule. As a result, the movement of the titanium oxide particle may be influenced. Accordingly, in situations where a liquid is deformed by instantaneous pressure such as during discharging in ink jet printing, the characteristics described above appear as difference in discharge characteristics. Therefore, the amount (mass %) of the compound represented by the formula (1) covalent-bonded to the titanium oxide particle may be, as the mass ratio to the content (mass %) of the titanium oxide particle, 0.001 times or less. When the mass ratio is greater than 0.001 times, the discharge stability of the ink may become insufficient. The mass ratio may be 0.0001 times or less. The amount of the compound represented by the formula (1) covalent-bonded to the titanium oxide particle can be calculated by thermogravimetric analysis or the like.

### Resin

The ink can contain a resin. Examples of the resin include an acrylic resin, a urethane resin, and a urea resin. In particular, the resin may be an acrylic resin. The content (mass %) of the resin in the ink is preferably 1.00 mass % or more and 25.00 mass % or less based on the total mass of the ink and further preferably 3.00 mass % or more and 15.00 mass % or less and particularly preferably 5.00 mass % or more and 15.00 mass % or less.

The ink can contain a resin in application to improve various characteristics of printed images, such as abrasion resistance and concealability. Examples of the form of the resin include a block copolymer, a random copolymer, a graft copolymer, and a combination thereof. The resin may be a water-soluble resin that can be dissolved in an aqueous medium or a resin particle that is dispersed in an aqueous medium. The resin particle does not need to contain a colorant.

In the present specification, “a resin is water-soluble” means that when the resin is neutralized with an alkali in an amount equivalent to the acid value, the resin is present in an aqueous medium without forming particles having a particle size that can be measured by a dynamic light scattering method. Whether a resin is water-soluble or not can be judged by the following method. A liquid containing a resin (resin solid content: 10 mass %) neutralized with an alkali (such as sodium hydroxide and potassium hydroxide) equivalent to the acid value is prepared. Subsequently, the prepared liquid is diluted with pure water by 10 times (volume basis) to prepare a sample solution.

The particle size of the resin in a sample solution is measured by a dynamic light scattering method. When no particle having a particle size is observed, the resin can be judged to be water-soluble. The measurement conditions on this occasion can be set to, for example, SetZero: 30 seconds, number of measurements: 3 times, and measurement time: 180 seconds. As the particle size distribution measurement apparatus, a particle size analyzer (e.g., trade name: UPA-EX150, manufactured by Nikkiso Co., Ltd.) by a dynamic light scattering method can be used. The particle size distribution measurement apparatus, the measurement conditions, and so on are not limited to the above.

The acid value of the water-soluble resin is preferably 80 mg KOH/g or more and 250 mg KOH/g or less and further preferably 100 mg KOH/g or more and 200 mg KOH/g or less. When a resin particle is used, the acid value thereof may be 0 mg KOH/g or more and 50 mg KOH/g or less. The resin preferably has a weight-average molecular weight of 1,000 or more and 30,000 or less and further preferably 5,000 or more and 15,000 or less. The weight-average molecular weight of a resin is a polystyrene-equivalent value measured by gel permeation chromatography (GPC).

### Aqueous Medium

The ink is an aqueous ink containing water as the aqueous medium. The ink can contain an aqueous medium that is water or a solvent mixture of water and a water-soluble organic solvent. As the water, deionized water (ion-exchanged water) may be used. The content (mass %) of water in the ink may be 50.00 mass % or more and 95.00 mass % or less based on the total mass of the ink.

The water-soluble organic solvent is not particularly limited as long as it is water-soluble (for example, soluble in water at 25° C. at an arbitrary ratio). Specifically, monovalent or polyvalent alcohols, alkylene glycols, glycol ethers, nitrogen-containing polar compounds, sulfur-containing polar compounds, and so on can be used. The content (mass %) of the water-soluble organic solvent in the ink is preferably 3.00 mass % or more and 50.00 mass % or less based on the total mass of the ink and further preferably 10.00 mass % or more and 40.00 mass % or less. When the content (mass %) of the water-soluble organic solvent is less than 3.00 mass %, the ink sticks to the ink jet printing apparatus, and sufficient sticking resistance may not be obtained. When the content (mass %) of the water-soluble organic solvent is greater than 50.00 mass %, poor ink supply may occur.

### Other Additives

The ink can contain a surfactant, a pH adjuster, a corrosion inhibitor, a preservative, an antifungal agent, an antioxidant, a reducing inhibitor, an evaporation promoter, a chelating agent, and so on as needed, in addition to the above additives. In particular, the ink may contain a surfactant. The content (mass %) of the surfactant in the ink is preferably 0.10 mass % or more and 5.00 mass % or less based on the total mass of the ink and further preferably 0.10 mass % or more and 2.00 mass % or less. Examples of the surfactant include an anionic surfactant, a cationic surfactant, and a nonionic surfactant. In particular, since the surfactant is used for adjusting various physical properties of the ink, the surfactant may be a nonionic surfactant which has low affinity to titanium oxide particles and shows effects at a small amount.

### Physical Property of Ink

Since the ink is an ink that is applied to an ink jet system, the physical properties thereof may be appropriately controlled. The surface tension at 25° C. of the ink is preferably 10 mN/m or more and 60 mN/m or less and further preferably 20 mN/m or more and 40 mN/m or less. The surface tension of an ink can be adjusted by appropriately determining the type and content of the surfactant in the ink. The viscosity of the ink at 25° C. may be 1.0 mPa·s or more and 10.0 mPa·s or less. The pH of the ink at 25° C. may be 7.0 or more and 9.0 or less. When the pH of the ink is within the above range, since the generation of a silanol group due to hydrolysis of the compound represented by the formula (1) progresses, the weak affinity between the titanium oxide particle and the compound represented by the formula (1) is effectively exhibited. The pH of an ink can be measured with a general pH meter loaded with a glass electrode.

### EXAMPLES

The present disclosure will now be described in further detail with reference to Examples and Comparative Examples, but is not limited to the following Examples in any way unless it exceeds the gist thereof. “Part” and “%” regarding a component amount are mass basis unless otherwise specified. A dispersion of a titanium oxide particle is referred to as “pigment dispersion”.

### Preparation of Titanium Oxide

Commercially available rutile titanium oxide particle that was surface-treated in advance was used. The volume-based cumulative 50% particle size (D₅₀) of the titanium oxide particle was measured using a particle size analyzer (trade name: Nanotrac WaveII-EX150, manufactured by MicrotracBEL Corporation) by a dynamic light scattering method. Characteristics of each titanium oxide particle are shown in Table 1.

TABLE 1
Characteristics of titanium oxide particle

| Titanium | | | | | |
|---|---|---|---|---|---|
| oxide | | | Surface | D₅₀ | Density |
| particle | Type | Manufacturer | treatment | (nm) | (g/cm³) |
| 1 | TIPAQUE | Ishihara Sangyo | alumina, | 250 | 4 |
| | PFC-211 | Kaisha, Ltd. | silica | | |
| 2 | TIPAQUE | Ishihara Sangyo | alumina, | 210 | 4 |
| | CR-60-2 | Kaisha, Ltd. | silica | | |

### Preparation of Pigment Dispersion

### Pigment Dispersion 1

A styrene-methyl methacrylate-methacrylic acid copolymer (resin 1) having an acid value of 150 mg KOH/g and a weight-average molecular weight of 10,000 was provided. An aqueous solution of the resin 1 in which the content of the resin (solid content) was 20.0% was prepared by neutralizing 20.0 parts of the resin 1 with potassium hydroxide in an amount equimolar to the acid value of the resin and adding an appropriate amount of pure water thereto. Ion-exchanged water was mixed with 40.0 parts of a titanium oxide particle 1 and 40.0 parts of an aqueous solution of the resin 1 such that the total of the components was 100.0 parts, and preliminary dispersion was performed using a homogenizer. Subsequently, dispersion treatment (main treatment) was performed in a paint shaker using 0.5-mm zirconium beads at 25° C. for 12 hours. The zirconia beads were removed by filtration, and an appropriate amount of ion-exchanged water was added to the filtrate as needed to prepare a pigment dispersion 1 in which the content of the titanium oxide particle was 40.0% and the content of the resin dispersion (resin 1) was 8.0%.

### Preparation of Ink

A mixture of 25.0 parts of the pigment dispersion 1 and the components shown below was stirred. Subsequently, pressure filtration with a membrane filter having a pore size of 5.0 μm (manufactured by Sartorius AG) was performed to prepare an ink 1. The detail of each of the mixed components is shown below:
Acrylic resin particle (trade name: Vinyblan 2685, manufactured by Nissin Chemical Industry Co., Ltd., Resin particle content: 30%): 20.0 parts;
Diethylene glycol: 10.0 parts;
Diethylene glycol isobutyl ether: 10.0 parts;
Fluorinated surfactant (trade name: Capstone FS-3100, manufactured by The Chemours Company): 1.0 parts; and
Ion-exchanged water: 34.0 parts.

The viscosity (Pa·s) of the ink 1 and the density (g/cm³) of the liquid component were 8 Pa·s and 1.16 g/cm³, respectively.

### Preparation of Reaction Liquid

Components shown below were mixed and sufficiently stirred, and the mixture was pressure-filtered through a cellulose aetate filter with a pore size of 3.0 μm (manufactured by Advantec Co., Ltd.) to prepare a reaction liquid 1.
Magnesium sulfate: 2.0%;
1,2-Butanediol: 20.0%;
Fluorinated nonionic surfactant (trade name: Capstone FS3100, manufactured by LEHVOSS Group): 0.5%;
Preservative (trade name: PROXEL GXL(S), manufactured by Arch Chemicals, Inc.): 0.2%; and
Ion-exchanged water: 77.3%.

When magnesium sulfate was added, magnesium sulfate heptahydrate was used to add the above amount of magnesium sulfate.

### Liquid Discharge Head

### Head 1

A liquid discharge head that is the liquid discharge head shown in FIGS. 2 to 5 and includes a temperature control heater and a temperature sensor for each of discharge port rows in the discharge element substrate 340 as temperature control units was prepared as a head 1.

### Head 2

A head 2 having the same configuration as the head 1 except that the temperature control units were not provided was prepared as a head 2.

### Evaluation

The ink 1 and the reaction liquid 1 were set to an ink jet printing apparatus loaded with the head 1 or head 2, and the ink was discharged in an environment of a temperature of 25° C. and a relative humidity of 50%. It was confirmed that the effects of the present disclosure are sufficiently obtained in the ink jet printing apparatus loaded with the head 1.

According to the present disclosure, it is possible to provide an ink jet printing method that can maintain stable discharge of a reaction liquid and can suppress occurrence of image unevenness.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-095973 filed Jun. 12, 2023, which is hereby incorporated by reference herein in its entirety.

What is claimed is:

1. An ink jet printing method for printing an image on a print medium by discharging each of an aqueous ink and an aqueous reaction liquid containing a reactant that reacts with the aqueous ink from a liquid discharge head, wherein
the liquid discharge head comprises:
an element substrate including a discharge port for discharging the aqueous reaction liquid, a pressure chamber for supplying a liquid to the discharge port, and a discharge element for generating energy for discharging the liquid;
an upstream flow channel for supplying a liquid to the pressure chamber;
a downstream flow channel communicating with the pressure chamber;
a pump communicating with the upstream flow channel and the downstream flow channel; and
a temperature control unit configured to heat the aqueous ink or the aqueous reaction liquid, and
the method comprises operating the pump such that a liquid in the downstream flow channel flow in the upstream flow channel.

2. The ink jet printing method according to claim 1, comprising:
discharging the aqueous reaction liquid from the discharge port to the print medium; and
applying the aqueous ink to the print medium so as to overlap with at least part of the region where the aqueous reaction liquid is applied.

3. The ink jet printing method according to claim 1, wherein the aqueous ink at 25° C. has a viscosity higher than that of the aqueous reaction liquid at 25° C.

4. The ink jet printing method according to claim 1, wherein the temperature control unit is disposed in the element substrate.

5. The ink jet printing method according to claim 4, wherein the element substrate includes a temperature sensor, the ink jet printing method further comprising measuring temperature of a discharge element substrate via the temperature sensor.

6. The ink jet printing method according to claim 4, wherein
the element substrate includes a first discharge port row in which a plurality of the discharge ports for discharging the aqueous ink is arranged and a second discharge port row in which a plurality of the discharge ports for discharging the aqueous reaction liquid is arranged, and
the temperature control unit is provided for each of the first discharge port row and the second discharge port row.

7. The ink jet printing method according to claim 1, wherein
the element substrate includes a plurality of discharge port rows in which the discharge ports including a first discharge port row and a second discharge port row are arranged,
the second discharge port row is located at an end in the arrangement direction of the plurality of the discharge port rows, and
the method comprises discharging the aqueous ink from the discharge ports in the first discharge port row, and discharging the aqueous reaction liquid from the discharge ports in the second discharge port row.

8. The ink jet printing method according to claim 1, wherein
the liquid discharge head comprises:
a plurality of the element substrates including a first element substrate and a second element substrate,
the second element substrate is located at an end in the arrangement direction of the plurality of the element substrates, and
the method comprises discharging the aqueous ink from the first element substrate, and discharging the aqueous reaction liquid from the second element substrate.

9. The ink jet printing method according to claim 1, wherein
the liquid discharge head comprises:
a discharge unit including the element substrate; and
a circulation unit including the pump and configured to circulate a liquid between the circulation unit and the discharge unit, and
the temperature control unit is disposed in the circulation unit.

10. The ink jet printing method according to claim 9, wherein the circulation unit is provided for each type of liquids that are discharged from the discharge port.

11. The ink jet printing method according to claim 1, further comprising operating the pump such that a volume of a liquid flowing in the circulation path is 5.0 mL or more and 30 mL or less.

12. The ink jet printing method according to claim 1, wherein the temperature control unit is disposed outside the liquid discharge head.

13. The ink jet printing method according to claim 1, wherein a liquid storage portion is connected to the liquid discharge head through a tube that is configured to supply the aqueous ink or the aqueous reaction liquid to the liquid discharge head.

14. The ink jet printing method according to claim 8, wherein the temperature control unit is disposed in the liquid storage portion.

15. The ink jet printing method according to claim 1, wherein the pump is a piezoelectric pump.

16. The ink jet printing method according to claim 1, further comprising scanning the liquid discharge head while discharging a liquid.

17. The ink jet printing method according to claim 5, wherein the liquid discharge head further includes a first pressure regulation unit that is configured to adjust a pressure of a liquid in the upstream flow channel.

18. The ink jet printing method according to claim 11, wherein the first pressure regulation unit includes a first valve chamber, a first pressure control chamber, a first opening communicating between the first valve chamber and the first pressure control chamber, and a first valve configured to be able to open and close the first opening.

19. The ink jet printing method according to claim 12, wherein the first pressure control chamber includes a first pressing plate that has a portion of its surface formed of a first flexible member configured to be displaceable and can be displaced in conjunction with the first flexible member and a first biasing member that energizes the first pressing plate in a direction in which the volume of the first pressure control chamber is increased and is configured such that the first valve can be opened and closed in response to displacement of the first pressing plate and the first flexible member.

20. The ink jet printing method according to claim 1, wherein the aqueous ink contains titanium oxide.
